(19) United States
(12) Patent Application Publication
(10) Pub. No.: US 2025/0348243 A1
(43) Pub. Date: Nov. 13, 2025

(54) Log-Based Coordination of Operations of a Host System to Reduce Garbage Collection in a Data Storage Device

(71) Applicant: Micron Technology, Inc., Boise, ID (US)

(72) Inventor: Luca Bert, Bologna (BO) (IT)

(21) Appl. No.: 19/174,587

(22) Filed: Apr. 9, 2025

Related U.S. Application Data
(60) Provisional application No. 63/644,318, filed on May 8, 2024.

(51) Int. Cl. G06F 3/06; G06F 12/02

(52) U.S. Cl. CPC G06F 3/0655; G06F 3/0604; G06F 3/0679; G06F 12/0253; G06F 2212/7205

(57) ABSTRACT

A memory sub-system, having: a host interface; memory cells having a storage capacity; and a controller configured to provide data storage services over the host interface using the storage capacity. The controller is configured to provide, in a log file, information related to garbage collection, such as a current usage level of the memory cells, a target usage level of the memory cells which when reached can trigger garbage collection in the memory sub-system, planned targets of garbage collection when the target usage level is reached. A host system can extract information from the log file to schedule and perform operations to reduce garbage collection in the memory sub-system.

### RELATED APPLICATIONS

The present application claims priority to Prov. U.S. Pat. App. Ser. No. 63/644,318 filed May 8, 2024, the entire disclosures of which application are hereby incorporated herein by reference.

### TECHNICAL FIELD

At least some embodiments disclosed herein relate to memory systems in general, and more particularly, but not limited to memory systems configured to support flexible direct placement (FDP).

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Flexible direct placement (FDP) is a recently developed technology for a host system to write data into a memory sub-system. When a communication protocol supporting flexible direct placement is used, the host system can specify a data placement directive in a write command sent from the host system to the memory sub-system. The data placement directive instructs the memory sub-system to write data into a reclaim unit having a set of memory cells that are configured to be erased together.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a technique for a host system and a memory sub-system to coordinate efforts related to garbage collection in a memory sub-system according to one embodiment.

FIG. 3 illustrates the monitoring of the usage levels of storage resources in a memory sub-system to trigger operations in a host system to reduce garbage collection operations in a memory sub-system according to one embodiment.

FIG. 4 and FIG. 5 illustrate host operations to reduce garbage collection operations in a memory sub-system according to one embodiment.

FIG. 6 shows reclaiming a unit of storage resources in a memory sub-system according to one embodiment.

FIG. 7 shows residual garbage collection in a memory sub-system according to one embodiment.

FIG. 8 shows a method to reduce garbage collection operations in a memory sub-system according to one embodiment.

FIG. 9 shows a technique to schedule operations of a host system to reduce garbage collection in a memory sub-system with minimal or no communications outside of storage access protocol for flexible direct placement according to one embodiment.

FIG. 10 shows a technique of tracking data placement information in a host system to facilitate operations of host folding according to one embodiment.

FIG. 11 shows a statistical analysis of history data of host folding to determine a condition to trigger host folding according to one embodiment.

FIG. 12 shows a method to schedule operations of a host system to reduce garbage collection in a memory sub-system with minimal or no communications outside of storage access protocol for flexible direct placement according to one embodiment.

FIG. 13 shows an example of a memory sub-system providing information via a log page to a host system to assist the host system in scheduling operations related to garbage collection in the memory sub-system according to one embodiment.

FIG. 14 shows a technique for a host system to schedule operations related to garbage collection in a memory sub-system according to one embodiment.

FIG. 15 illustrates a log page provided from a memory sub-system to coordinate operations of a host system related to garbage collection in the memory sub-system according to one embodiment.

FIG. 16 shows a method to schedule operations of a host system related to garbage collection in a memory sub-system via a log page in the memory sub-system according to one embodiment.

FIG. 17 is a block diagram of an example computer system in which embodiments of the present disclosure can operate.

### DETAILED DESCRIPTION

At least some aspects of the present disclosure are directed to coordination between a host system and a memory sub-system to reduce garbage collection operations in the memory sub-system (e.g., a data storage device, such as a solid-state drive).

A conventional memory sub-system can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

When a block of memory cells has some pages that can be erased and other pages that have valid data, the memory sub-system can perform the operation of garbage collection in which the valid data is copied from the block and written to outside of the block. After the valid data is copied to outside of the block, the entire block can be erased to reclaim the storage resources of the block without data loss. However, copying the valid data from a block for the purpose of erasing the block (so that the previously programmed pages in the block can be again programmed to store new data) increases the activities of programming memory cells to write data and thus leads to increased write amplification (e.g., the ratio between the amount of data being programmed to preserve host data in the storage media of the memory sub-system and the amount of the host data being preserved). Increased write amplification can reduce the performance of the memory sub-system and/or the useful life of the memory cells in the memory sub-system.

A conventional host system is configured to instruct a memory sub-system to store data at locations specified via logical addresses. The memory sub-system can have a flash translation layer configured to map the logical addresses as known to the host system to physical addresses of memory cells in the memory sub-system. As a result, the host system may not be aware which data items are stored in a block having pages configured to be erased together and thus may have fewer options in assisting the reduction of garbage collection and/or write amplification in the memory sub-system.

Flexible direct placement (FDP) is a recently developed technology that supports a communication protocol between a host system and a memory sub-system. With flexible direct placement (FDP), the host system can be aware of which data items are stored together in a unit of memory cells that are configured to be erased together during reclaiming storage resources in the memory sub-system. Such a unit can be referred to as a reclaim unit (RU) (e.g., as in flexible direct placement (FDP)).

Standard protocols for communications between a host system and a memory sub-system, with or without the technology of flexible direct placement (FDP), have not yet been developed to offer sufficient mechanisms that can be used to facilitate cooperation between the host system and the memory sub-system in the reduction of garbage collection in the memory sub-system. An overly aggressive approach implemented to reduce garbage collection can degrade the performance of the system, while the lack of effort to reduce garbage collection can reduce the benefit of write amplification reduction opportunities offered by flexible direct placement (FDP) and/or similar techniques.

At least some aspects of the present disclosure address the above and other deficiencies and challenges by arranging, in a suitable time window, host activities configured to reduce garbage collection in the memory subsystem and thus to harvest the benefit of write amplification reduction without overly aggressive implementations of such activities. The techniques can be implemented with little or no support in standardized protocols for communications between a host system and a memory sub-system, as discussed in further details below.

Flexible direct placement (FDP) (or similar technologies) allows a host system to specify on which reclaim unit handle (RUH) data should be placed by a memory sub-system. A memory sub-system (e.g., a solid-state drive) supporting flexible direct placement (FDP) can expose, to a host system, a number of reclaim unit handles (e.g., 8 to 16 in most common cases but 100's or 1000's are possible). Each reclaim unit handle can independently buffer data received from the host system for writing the data to a separate reclaim unit. Different reclaim unit handles write data to different reclaim units.

For a command sent to write data to the memory sub-system, the host system can specify, via a data placement directive of a write command, on which reclaim unit handle the data to be written should be placed. The memory sub-system can use the data placement directive to write the data on the specific cursor assigned to the reclaim unit handle. The cursor identifies a reclaim unit having a set of memory cells that are grouped together for erasure.

The use of the data placement directive allows the host system to aggregate data of likewise life on the same reclaim unit handle so that they will be deleted at about the same time to minimize the amount of garbage collection, resulting in improvements in both the performance and the endurance of the memory sub-system.

In general, reclaim units configured in a memory sub-system can have a same size known to the host system. A reclaim unit can have a plurality of blocks of memory cells. It is permissible for a host system to write logical blocks randomly into a reclaim unit; and logical blocks from different namespaces can be written into a same reclaim unit. Thus, the logical addresses of data stored in a reclaim unit can be random and/or configured in different namespaces. The flexibility offers improved opportunities for the host system to group data of likewise life for deletion at about the same time.

In general, a host system can have multiple tenants of the storage space offered by the memory sub-system. A tenant can be a writer that controls the life cycle of data being written into the memory sub-system. For example, a tenant can be an application or an instance of the application running for a particular user of the host system. A portion of the operating system running in the host system can be configured to perform data input/output operations on behalf of the tenants via issuing data storage access commands (e.g., read, write, delete, trim) to the memory sub-system.

There can be a mismatch between the possible number of writers and the practical number of reclaim unit handles that can be supported in a memory sub-system within expected performance and endurance requirements (e.g., 8 or 16 can be a most common number). The possible number of writers can scale with the number of cores of the host system (and hence can easily be within the 100's). Thus, many writers (e.g., several tens, possibly 100's) in a host system can write on a same reclaim unit handle (e.g., for data having similar expected life).

When the number of free reclaim units available in the memory sub-system to write data is low, it can trigger the operations of garbage collection in the memory sub-system. Potentially, there can be a race condition on two fronts. On one front, the host system may try to remove data from certain reclaim units before the memory sub-system starts its garbage collection operations. On the other front, the host system and the memory sub-system may not agree on which reclaim unit is to be selected for targeted data removal. For example, the host system may decide, based on information available to the host system, that a particular reclaim unit is a good target for freeing up storage resources; and the memory sub-system may decide, based on its own policies, that another reclaim unit is a good candidate for garbage collection. From the one side, the memory sub-system may be eager to perform garbage collect to reclaim free storage resources usable for the reclaim unit handles; and from the other side, the host system may be eager to start efforts to empty selected reclaim units to free the storage resources before the memory sub-system starts garbage collection, so that write amplification is kept to a minimum.

There can be many writers/tenants in the host system targeting a specific reclaim unit, which makes things more complex, because each writer can only address its portion of data. It is best that the operating system running in the host system coordinates the writers so that the writers using the same reclaim unit complete their operations to invalidate their data in the reclaim unit before the memory sub-system starts its garbage collection operations. This can be quite a complex operation and may take several seconds, which can be long enough that the garbage collection operations in the memory sub-system have kicked in and done the job of copying data to another reclaim unit, just before the writers invalidate them. As the data is now residing in a different reclaim unit as the result of garbage collection in the memory sub-system, invalidating the data does not help write amplification reduction and does not reduce garbage collection.

At least some embodiments disclosed herein provide a clean slate approach that is based on a level of coordination between the host system and the memory sub-system in scheduling the operations related to garbage collection. The techniques disclosed herein allow for orderly execution from tenants in the host system to reduce valid data in reclaim units before the host system relinquishes control to the memory sub-system. The operations can be done in a way that is minimally intrusive to existing protocols (e.g., nonvolatile memory express (NVMe) protocol).

Optionally, some techniques disclosed herein allow the host system and the memory sub-system to agree on which reclaim unit needs to be cleaned for erasure with minimal garbage collection. After the host system completes its operations to clean a reclaim unit, which operations may be referred to as host folding, the host system may relinquish control of garbage collection related operations and the memory sub-system can finalize the garbage collection of copying the remaining valid data (if any) from the targeted reclaim unit to another location for the erasure of the targeted reclaim unit.

In general, there can be many ways to accomplish the orderly execution of operations to reclaim the storage resources of a reclaim unit. However, some approaches would collide with existing protocols (e.g., NVMe protocol). The techniques discussed below involve minimal or no changes to the existing protocols and leverage existing infrastructure.

One simplified approach to coordinate the activities related to garbage collection between a host system and a memory sub-system is to simply disable garbage collection in the memory sub-system by default. Another approach is to add a command in the protocol for communications between host systems and memory sub-systems, where the command can be issued by a host system to stop garbage collection in the memory sub-system that receives the command. When such approaches are used, the memory sub-system may potentially fail to function properly when the host system fails to manage the tenants to free up sufficient reclaim units. In a further approach, the default setting of disabling garbage collection or the command of disabling garbage collection can be automatically reversed by the memory sub-system when it becomes necessary to perform garbage collection in order for the memory sub-system to function properly.

Typically, a memory sub-system is configured to refrain from performing garbage collection until the level of free blocks available in the memory sub-system falls below an internal threshold.

A host system can be configured to estimate or predict such a condition that leads to the onset of garbage collection. For example, the host system can be configured to perform the estimation or prediction based on information available to the host system (e.g., via flexible direct placement).

For example, the host system can determine how many reclaim units are available in the memory sub-system, and how many reclaim units have valid data, and hence the ratio between them. Such a ratio indicates the level of storage resource usages in the memory sub-system. With such an estimate of the level of storage resource usages and a margin below an internal threshold of the memory sub-system, the host system can identify a good operational zone where the host knows that the memory sub-system is not going to perform garbage collection. After a further increase in the level of storage resource usages to beyond the internal threshold of the memory sub-system, garbage collection can happen in the memory sub-system. Host folding can be scheduled within such an operational zone identifiable by the host system with little or no support in the protocol for communications between host systems and memory sub-systems. A trade-off in such an approach is the need for a significant margin below the internal threshold of the memory sub-system, which can be difficult to optimize.

In a further approach, the memory sub-system is configured to report (e.g., via an NVMe log page) information about the level storage resource usages in the memory sub-system. The host system can determine, based on the information reported by the memory sub-system (e.g., via reading the log page), when the memory sub-system is going to start its garbage collection operations. Optionally, the memory sub-system can report the threshold number of reclaim units such that after the threshold number of reclaim units have been used, the memory sub-system is to trigger garbage collection operations. The host system can then determine a more precise margin for the operational zone of host folding, before the memory sub-system starts its garbage collection operations.

Such approaches work not only with memory sub-systems supporting flexible direct placement, but also with memory sub-systems supporting zoned namespace (ZNS). The technique of zoned namespace allows a host system to specify the writing of data into a zone allocated in a namespace, where the memory resources allocated to the zone are grouped together for erasure. Such a zone in zoned namespace can be considered a reclaim unit. However, a zoned namespace does not support random writes in a zone of a namespace and are limited to store data for the particular namespace in which the zone is allocated. Thus, reclaim units implemented via zoned namespace (ZNS) are less flexible than reclaim units implemented via flexible direct placement (FDP).

In one implementation, the host system is configured to monitor the level of storage resource usage in the memory sub-system (e.g., based on the ratio between the number of used reclaim units in the memory sub-system and the number of total reclaim units in the memory sub-system). When the level comes close to the threshold beyond which the memory sub-system is likely to start garbage collection operations, the host system can start its host folding operations.

The host system can be configured to start host folding well in advance of the level reaching the threshold such that the host system has sufficient time to complete its host folding operations to best harvest the benefit of reducing garbage collection in the memory sub-system. For example, the host system can be configured to monitor the write throughput it actually generates for the memory sub-system and determine a time to start its host folding operations such that during the time period of its host folding operations the level of storage resource usage does not reach the threshold.

To start host folding operations, the host system is configured to select a victim reclaim unit to reduce or empty valid data in the reclaim unit so that the victim reclaim unit can be erased with reduced or no residual valid data to be copied in order to reclaim the storage resources of the victim reclaim unit.

For example, based on the information available in the host system, the host system can determine how dirty a reclaim unit is (i.e., how big is the ratio between the size of valid data remaining in the reclaim unit and the storage size of the reclaim unit). Further, the host system can predict how much longer the data in the reclaim unit is needed by the respective tenants. Based on the information about the reclaim units, the host system can select a victim reclaim unit (e.g., a reclaim unit where valid data can be reduced in a short period of time to minimize data to be copied in a garbage collection operation). Since the host system has information about both the logical and physical data affiliation, the host system is in general in a better position to select a victim reclaim unit than the memory sub-system. In contrast, since the memory sub-system knows physical affiliation but not logical affiliation, the effectiveness of a choice made by the memory sub-system can be limited by a partial view.

After a victim reclaim unit is selected, the host system can start host folding operations. For example, the host system can start with instructing the tenants of the victim reclaim unit to reduce their valid data stored in the logical addresses mapped to the victim reclaim unit. Host folding ends with the tenants completing with their responses. This can be a rather slow process; and thus in deciding how soon the host folding needs to start, the host system is to account for the time to be used in completing the host folding operations.

After host folding operations, the memory sub-system can complete its residual garbage collection operations if needed.

In one approach of targeted erasure of reclaim units, the firmware of the memory sub-system is to select a reclaim unit that has the least amount of valid data to be moved. Since the host system has performed operations to reduce valid data in a victim reclaim unit it is likely that the victim reclaim unit selected by the host system is the reclaim unit having no valid data, or the least amount of valid data to be moved. Statistically, the memory sub-system is likely to select victim reclaim units selected by the host system for host folding operations, even without explicit communications between the host system and the memory sub-system in identifying the victim reclaim unit to the memory sub-system. If the memory sub-system for any reason every so often picks a different reclaim unit for erasure, its statistical significance can be minimal.

In a more precise approach of targeted erasure of reclaim units, the host is configured to explicitly inform the memory sub-system about the victim reclaim unit that it has been folded during the host folding operations. Such an approach can include the introduction of a new command in the protocol for communications between host systems and memory sub-systems. A change in the communication protocol is small but rather intrusive. However, the benefit of the change is that the memory sub-system can erase precisely the victim reclaim unit selected by the host system with 100% accuracy.

The advantages of the above discussed techniques are, if the host system operates exactly as described above, almost no garbage collection (e.g., copying valid data for the purpose of erasing memory cells) would happen in the memory sub-system, which thus maximizes the life and performance of the memory sub-system. However, if the host system fails at times to operate as described, the memory sub-system can still fall back on its existing operational mode of garbage collection and thus can be functional in delivering at least at the existing levels.

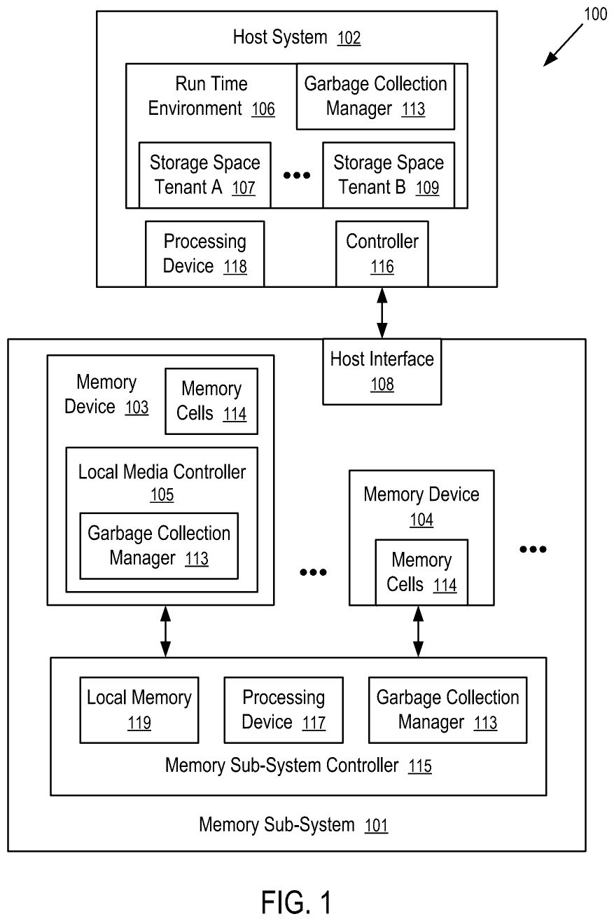

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a garbage collection manager 113 configured to perform operations related to garbage collection in the memory sub-system 101. In some embodiments, the controller 115 in the memory sub-system 101 includes at least a portion of the garbage collection manager 113. In other embodiments, or in combination, the controller 116 and/or the processing device 118 in the host system 102 includes at least a portion of the garbage collection manager 113. For example, the controller 115, the controller 116, and/or the processing device 118 can include logic circuitry implementing the garbage collection manager 113. For example, the controller 115, or the processing device 118 (processor) of the host system 102, can be configured to execute instructions stored in memory for performing the operations of the garbage collection manager 113 described herein. In some embodiments, the garbage collection manager 113 is implemented in an integrated circuit chip disposed in the memory sub-system 101. In other embodiments, the garbage collection manager 113 can be part of firmware of the memory sub-system 101, an operating system of the host system 102, a device driver, or an application, or any combination therein.

For example, the garbage collection manager 113 implemented in the controller 115 and/or 105 of the memory sub-system 101 can be configured to perform garbage collection operations of copying valid data from a reclaim unit to outside of the reclaim unit before erasing the reclaim unit and reclaiming the storage resources of the reclaim unit. Optionally, the garbage collection manager 113 in the memory sub-system 101 can be further configured to communicate, to the host system 102, an indication of the condition that when satisfied, the memory sub-system 101 starts its garbage collection operations. Optionally, the garbage collection manager 113 in the memory sub-system 101 can be further configured to process a command from the host system 102 that identifies a reclaim unit for erasure and thus perform residual garbage collection operations for the reclaim unit if the reclaim unit has remaining valid data. Optionally, the garbage collection manager 113 can be further configured to process a command from the host system 102 that requests the memory sub-systems to stop garbage collection function in general, or start garbage collection in general, or start garbage collection for the erasure of a reclaim unit identified in the command, or delay garbage collection in general for a period of time specified in the command, or delay garbage collection for a reclaim unit identified in the command for a period of time. Optionally, the garbage collection manager 113 can be further configured to store the resource usage information in a log file to assist the host system 102 in the determination of when to start host folding operations. Optionally, the garbage collection manager 113 can be further configured to report to the host system 102 (e.g., via asynchronous event reporting (AER)) a need for host folding.

For example, the garbage collection manager 113 implemented in the host system 102 can be configured to determine when to start host folding operations of communicating with storage space tenants 107, . . . , 109 in the run time environment 106 of the host system 102 to reduce valid data in a victim reclaim unit. The garbage collection manager 113 in the host system 102 can be further configured to track information about the usages of reclaim units in the memory sub-system 101 and select the victim claim unit based on the tracked information. Further, the garbage collection manager 113 can be configured to perform the host folding operations. Optionally, the collection manager 113 can be configured to communicate with the memory sub-system 101 (e.g., via a log file) to determine the current usage level of storage resources and thus whether to select a victim reclaim unit for host folding operation. Optionally, the collection manager 113 can be configured to receive notifications from the memory sub-system 101 (e.g., via asynchronous event reporting (AER)) a need for host folding. Optionally, the collection manager 113 can be configured to communicate with the tenants 107, . . . , 109 to determine an estimate of time to complete folding a reclaim unit and thus a suitable time to start host folding operations. Optionally, the collection manager 113 can be configured to determine an estimate of time to complete folding a reclaim unit without requesting the tenants to provide their estimations. Optionally, the collection manager 113 can be configured to prioritize activities of the tenants to accelerate folding of a victim reclaim unit. Optionally, the collection manager 113 can be configured to send a command to the memory sub-system 101 to identify a reclaim unit for erasure, the start, stop or delay garbage collection in the memory sub-system 101 in general or for a particular reclaim unit identified in the command.

Further details of the operations of the garbage collection managers 113 in the host system 102 and in the memory sub-system 101 are discussed below.

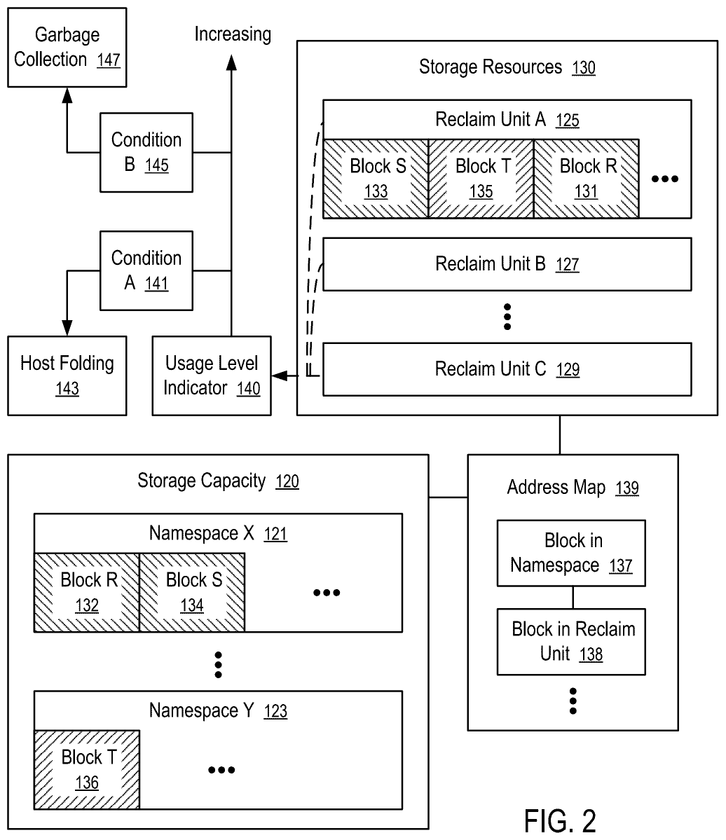

FIG. 2 shows a technique for a host system and a memory sub-system to coordinate efforts related to garbage collection in a memory sub-system according to one embodiment. For example, the technique of FIG. 2 can be implemented in the computing system of FIG. 1 via the garbage collection managers 113.

In FIG. 2, a memory sub-system 101 (e.g., as in FIG. 1) maintains an address map 139 that is configured to identify the mapping between logical blocks (e.g., 137) defined in namespaces (e.g., 121, . . . , or 123) and physical blocks (e.g., 138) of storage resources (e.g., memory cells) that are currently allocated as storage media to store the data of the logical blocks (e.g., 137).

The memory sub-system 101 has a storage capacity 120 (e.g., storage capability provided by memory cells 114 in the memory devices 103, . . . , 104 in the memory sub-system 101 illustrated in FIG. 1). Different portions of the storage capacity 120 can be allocated to different namespaces (e.g., 121, . . . , 123). Within each namespace (e.g., 121 or 123), logical block addresses can be defined sequentially, starting from zero. The namespaces (e.g., 121, . . . , 123) and the logical block addresses defined in the namespaces (e.g., 121, . . . , 123) allow a host system 102 (e.g., as in FIG. 1) to specify the location of writing a block of data into the memory sub-system 101 or reading the block of data.

The memory sub-system 101 has physical storage resources (e.g., memory cells 114 in the memory devices 103, . . . , 104 in the memory sub-system 101 illustrated in FIG. 1). For example, the memory cells 114 in the memory sub-system 101 can be physically structured in pages of memory cells, blocks of pages, and planes of blocks.

The memory sub-system 101 can organize or group of storage resources (e.g., blocks of memory cells) into a reclaim unit (e.g., 125, 127, . . . , or 129) such that the memory cells in a reclaim unit can be erased together, before the storage resources can be programmed again to store new data. For example, the memory cells in each reclaim unit (e.g., 125, 127, . . . , or 129) can be erased without erasing any memory cells outside of the reclaim unit (e.g., 125, 127, . . . , or 129).

To store a block of data at a logical block address (e.g., corresponding to block 134 defined in the namespace 121), the memory sub-system 101 can allocate a block 133 of storage resources in the reclaim unit 125 as the media for the logical block 134. For example, the block 133 of storage resources can be one or more pages of memory cells allocated from one or more blocks of pages. In a typical implementation, the data size of the block 132 in the namespace 121 (e.g., identify via a logical block address defined in the namespace 121) is smaller than the storage capacity of a block of pages that are structured/wired to be erased together. Thus, the block 133 of storage resource in the reclaim unit 125 is not necessarily an entire block of pages.

The data of the logical block 132 in the namespace 121 can be stored in the media/storage resources in the block 133 of the reclaim unit 125. For example, to store the data, one or more pages of memory cells allocated as the block 133 of storage resources 130 can be programmed to have states (e.g., threshold voltage levels) that represent the data stored in the memory cells. The block of data can be retrieved from the media via a read command identifying the logical block address of the block 134 in the namespace 121. For example, the states (e.g., threshold voltage levels) that represent the data stored in the memory cells can be examined in a read operation to determine the data stored in the memory cells.

Instead of using a predetermined relation between the block 134 in the namespace 121 and the block 133 in the reclaim unit 125, the memory sub-system 101 maintains the address map 139 to indicate that the media of the block 134 in the namespace 121 is the block 133 in the storage resources 130. Using the address map 139, the memory sub-system 101 can translate (e.g., via a flash translation layer of the memory sub-system 101) the logical block address of the block 134 in the namespace 121 to the physical address of the block 133 in the storage resources 130.

In one implementation, the memory sub-system 101 supports flexible direct placement (FDP). Using a communication protocol supporting flexible direct placement (FDP), the host system 102 can write blocks (e.g., 134, 136) of different namespaces (e.g., 121, 123) into a same reclaim unit (e.g., 125). Further, the host system 102 can write blocks of a namespace (e.g., 121 or 123) into a reclaim unit (e.g., 125) in a random order, instead of sequentially.

The memory sub-system 101 has a degree of flexibility in allocating blocks of storage resources (e.g., memory cells) to a reclaim unit (e.g., 125). For example, the blocks (e.g., 131, 133, 135) of storage resources do not have to be a contiguous section of memory cells on an integrated circuit die. The blocks (e.g., 131, 133, 135) of storage resources can be allocated from different planes and/or integrated circuit dies. However, the blocks of storage resources allocated to each reclaim unit (e.g., 125) are such that the reclaim unit (e.g., 125) is erasable without erasing any storage resources outside of the reclaim unit (e.g., 125).

Using a protocol supporting flexible direct placement (FDP), the host system 102 can specify a data placement directive in a write command to request the use of a reclaim unit handle operating on the reclaim unit 125 to store data provided by the host system 102. With the data placement directive, the host system 102 can write to the block 134 in the namespace 121, causing the block 133 in the reclaim unit 125 to be used as the media for the block 134 and thus mapped accordingly in the address map 139. For example, in the address map 139, block 137 can identify block 134 in the namespace 121; and the associated block 138 can identify the physical block 133 in the reclaim unit 125 as the media of the logical block 134 in the namespace.

Subsequently, the host system 102 can use the same reclaim unit handle to write to the block 136 in a different namespace 123, causing the subsequent block 135 in the reclaim unit 125 to be used as the media for the block 136 in the namespace 123. Since the host system 102 uses the same reclaim unit handle to write the block 134 in the namespace 121 and the block 136 in the namespace 123, the host system 102 knows that the blocks 134 and 136 are stored into the same reclaim unit 125. For example, when the host system 102 determines that the blocks 134 and 136 have likewise life, the host system 102 can use the same reclaim unit handle to place their data together in a same reclaim unit 125. For example, the data of the blocks 134 and 136 can be from different storage space tenants (e.g., 107, 109 in FIG. 1).

Subsequently, the host system 102 can further use the same reclaim unit handle to write to the block 132 in the namespace 121, causing the block 131 in the reclaim unit 125 to be used as the media for the block 132. Thus, the reclaim unit 125 can host data of different namespaces (e.g., 121, 123) in a random order.

In one implementation, an indicator 140 of usage level of the storage resources 130 is used to coordinate the operations of the garbage collection managers 113 in the host system 102 and in the memory sub-system 101, with little or no additional communications outside of the current protocol for communications between host systems and memory sub-systems (e.g., NVMe protocol).

For example, the indicator 140 can be configured to show the ratio of the number of reclaim units that have valid data and the total number of reclaim units in the storage resources 130 of the memory sub-system 101. As the usage level indicator 140 increases, the number of free reclaim units usable to write new data decreases. When the usage level indicator 140 increases to meet one condition 141 (e.g., a lower threshold, or watermark of usage level), the host system 102 can start its operations of host folding 143 (e.g., communicating with the storage space tenants to request the tenants to perform operations to reduce valid data in a victim reclaim unit (e.g., 125)). It can take a period of time for the host folding 143 to be effective in reducing valid data in a victim reclaim unit (e.g., 125) for a successful completion. In some instances, when valid data cannot be completely removed from the victim reclaim unit (e.g., 125) within a predetermined time window allocated for the operations of host folding 143, the operations of host folding 143 can be terminated to accept the achieved reduction as a best-effort result. Subsequently, as the indicator 140 increases to another condition (e.g., a higher threshold, or watermark of usage level), the memory sub-system 101 can start garbage collection 147, while the host system 102 refrains from operations of host folding 143 to avoid a racing condition.

During the period of host folding 143, the usage level indicator 140 can continue to increase. When the usage level indicator 140 increases to meet another condition 145 (e.g., a threshold higher than the threshold of the condition 141), the memory sub-system 101 can start its operations of garbage collection 147 (e.g., copying valid data from the reclaim unit 125 to another reclaim unit (e.g., 129) for the erasure of the reclaim unit 125).

To coordinate the host folding 143 in the host system 102 and the garbage collection 147 in the memory sub-system 101, the conditions 141 and 145 are configured such that the host folding 143 and the garbage collection 147 are not performed concurrently. For example, when the usage level indicator 140 reaches the condition 145, the garbage collection manager 113 in the host system 113 can pause or stop its operations of host folding 143 and thus relinquishes control to the garbage collection manager 113 in the memory sub-system 113. Such an arrangement reduces and/or avoids the race condition discussed above, while the benefit of write amplification reduction is increased or maximized.

In one embodiment, the conditions 141 and 145 correspond to watermarks of the usage of the storage resources 130 in triggering host folding 143 in the host system 102 and triggering garbage collection 147 in the memory sub-system 101 respectively. The memory sub-system 101 and the host system 102 can communicate with each other to set and/or negotiate the watermarks. Optionally, the memory sub-system 101 can report the condition 145 to the host system 102 to allow the host system 102 to determine/select the condition 141. Alternatively, the conditions 141 and 145 can be separately coded into the host system 102 and the memory sub-system 101 based on statistical data. Alternatively, the host system 102 can select the conditions 141 and 145 and request the memory sub-system 101 to refrain from garbage collection 147 before the indicator 140 reaches the condition 145.

Preferably, the conditions 141 and 145 are selected such that the time gap for the usage level indicator 140 to increase from the condition 141 to the condition 145 is minimized (e.g., to reduce impacts on the normal operations of the host system 102), but is sufficient to allow the host folding 143 to maximize the benefit of effectively reducing as much valid data as possible from one or more reclaim units.

For example, under a typical operating condition of the computing system 100 having the host system 102 and the memory sub-system 101, different selections of the condition 141 relative to the condition 145 (e.g., having gaps of different sizes between the conditions 141 and 145) can be used to test the cost and benefit of the selections. A cost function can be used to penalize the cost of starting host folding 143 too soon, and to reward the benefit of write amplification reduction resulting from reduced valid data in one or more victim reclaim units (e.g., 125). From the test runs/selections, a statistically optimized selection of the condition 141 relative to the condition 145 can be used for subsequent triggering of the operations of host folding 143. For example, the statistically optimized selection of the condition 141 is selected through minimizing the cost function against the test runs/selections.

For example, when a selection of the condition 141 is used to trigger the operations of host folding 143, the garbage collection manager 113 in the host system 102 can record the time gap for the usage level indicator 140 to increase from the condition 141 to the condition 145. Optionally, the garbage collection manager 113 in the host system 102 can further record the time gap between the completion of host folding 143 and the indicator 140 increasing to the condition 145; and the this time gap can be penalized more heavily than the time gap between the conditions 141 and 145.

Further, the host system 102 can record the size of valid data that has been successfully removed from one or more victim reclaim units during the host folding 143. The time gap (or time gaps) and the data size can be used as in the cost function to quantify the cost and benefit of the selection of the condition 141 in one instance of host folding 143. Data points corresponding to multiple instances of host folding 143 triggered by the same selection of the condition 141 can be collected. Further, data points corresponding to multiple instances of host folding 143 triggered by different selections of the condition 141 can be collected. From the collected data points, a statistically optimized selection of the condition 141 that minimizes the cost function can be computed.

Optionally, the tests/selections can be repeated for different patterns of operation conditions of the computing system 100. Thus, when the pattern of the current operating conditions changes, the corresponding statistically optimized selection of the condition 141 for the current pattern can be looked up and deployed.

In some implementations, after the garbage collection manager 113 in the host system 102 completes its operations of host folding 143 targeting a victim reclaim unit (e.g., 125), the usage level indicator 140 is above the condition 141 but not yet reaching the condition 145 for garbage collection 147. In such situations, the garbage collection manager 113 in the host system 102 can further select another victim reclaim unit (e.g., 127) for its host folding operation 143, until the usage level indicator 140 reaches the condition 145.

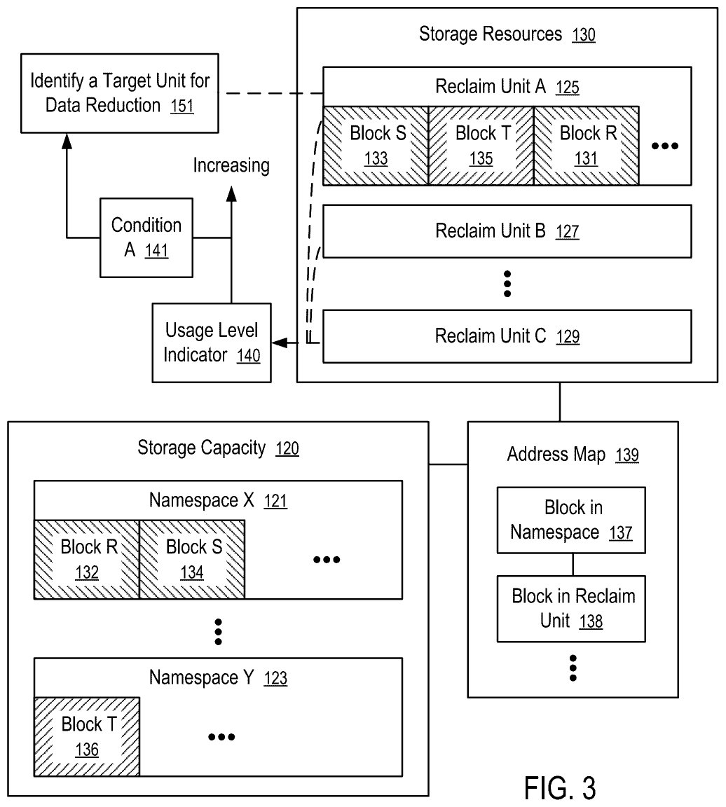

FIG. 3 illustrates the monitoring of the usage levels of storage resources in a memory sub-system to trigger operations in a host system to reduce garbage collection operations in a memory sub-system according to one embodiment. For example, the monitoring as illustrated in FIG. 3 can be implemented as part of the technique of FIG. 2.

For example, the usage level indicator 140 can be monitored to determine whether it satisfies the condition 141 (e.g., a condition of the indicator 140 being higher than a lower threshold, as in FIG. 2).

In response to the usage level indicator 140 being determined to meet the condition 141, a victim reclaim unit (e.g., 125) can be identified 151 as a target unit for reduction of valid data during host folding 143.

For example, the garbage collection manager 113 in the host system 102 can be configured to track the amounts of valid data remaining in reclaim units (e.g., 125, 127, . . . , 129) in the storage resources 130 of the memory sub-system 101. Further, the garbage collection manager 113 in the host system 102 can be configured to estimate how close the valid data is expected to be invalidated by respective tenants (e.g., 107, . . . , 109). Based on the information about the valid data remaining in the reclaim units (e.g., 125, 127, . . . , 129), the garbage collection manager 113 in the host system 102 can select a victim reclaim unit that is likely to have a least amount of residual valid data after the host folding 143 and before the usage level indicator 140 reaches the next condition 145 (e.g., in FIG. 2) for garbage collection 147.

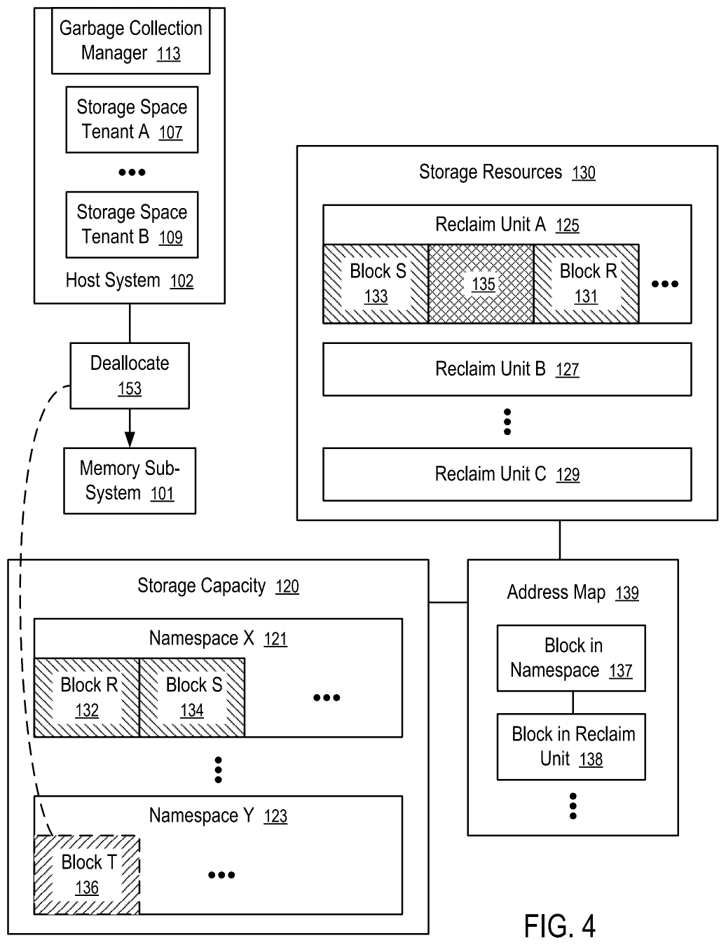

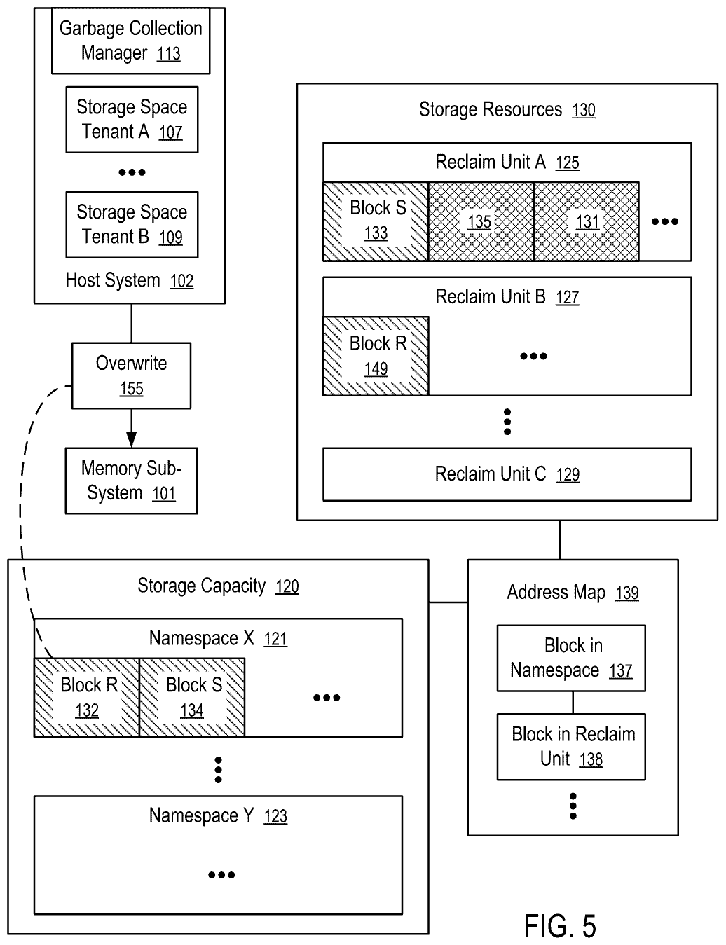

After the selection of a victim reclaim unit (e.g., 125), the garbage collection manager 113 in the host system 102 can perform the operations of host folding 143 as illustrated in FIG. 4 and FIG. 5.

FIG. 4 and FIG. 5 illustrate host operations to reduce garbage collection operations in a memory sub-system according to one embodiment.

During the operations of host folding 143, the garbage collection manager 113 in the host system 102 identifies owners/tenants of the blocks (e.g., 132, 134, 136) of data stored in the victim reclaim unit 125. The owners can be a subset of storage space tenants 107, . . . , 109 in the host system 102. The garbage collection manager 113 in the host system 102 communicates with the owners to expedite the invalidation of the valid data in the victim reclaim unit 125 before the indicator 140 reaches the next condition 145 for garbage collection 147.

As an example, the garbage collection manager 113 in the host system 102 determines that the owner of the block 136 in the namespace 123 is the storage space tenant 109. Thus, the garbage collection manager 113 requests the tenant 109 to expedite invalidation of the data in the block 136 in the namespace 123 within a specified period of time.

In response, the tenant 109 may complete its use of the data stored in the block 136 and cause the garbage collection manager 113 in the host system 102 to issue a command to the memory sub-system 101 to deallocate 153 (or delete) the block 136, as illustrated in FIG. 4. As a result, the memory sub-system 101 can store data indicating that the block 135 of storage resources now does not store valid data (and thus can be erased).

As another example, the garbage collection manager 113 in the host system 102 determines that the owner of the blocks 132 and 134 in the namespace 121 is the storage space tenant 107. Thus, the garbage collection manager 113 requests the tenant 107 to expedite invalidation of the data in the blocks 132 and 134 in the namespace 121 within a specified period of time.

In response, the tenant 109 may complete its use of the current data stored in the block 136, generate new data for the block 136 in the namespace 121, and cause the garbage collection manager 113 in the host system 102 to overwrite 155 the block 132, as illustrated in FIG. 5. Since the block 131 in the reclaim unit 125 has not yet been erased, the block 131 of storage resources cannot be used to store the new data for the block 132 in the namespace 121. Thus, the memory sub-system 101 allocates a block 149 of storage resources from another reclaim unit 127 as the current media allocated for the block 132 in the namespace 121; and the address map 139 is updated accordingly to indicate the association between the block 132 in the namespace 121 and the block 149 in the reclaim unit 127. As a result, the memory sub-system 101 can store data indicating that the block 131 of storage resources now does not store valid data (and thus can be erased).

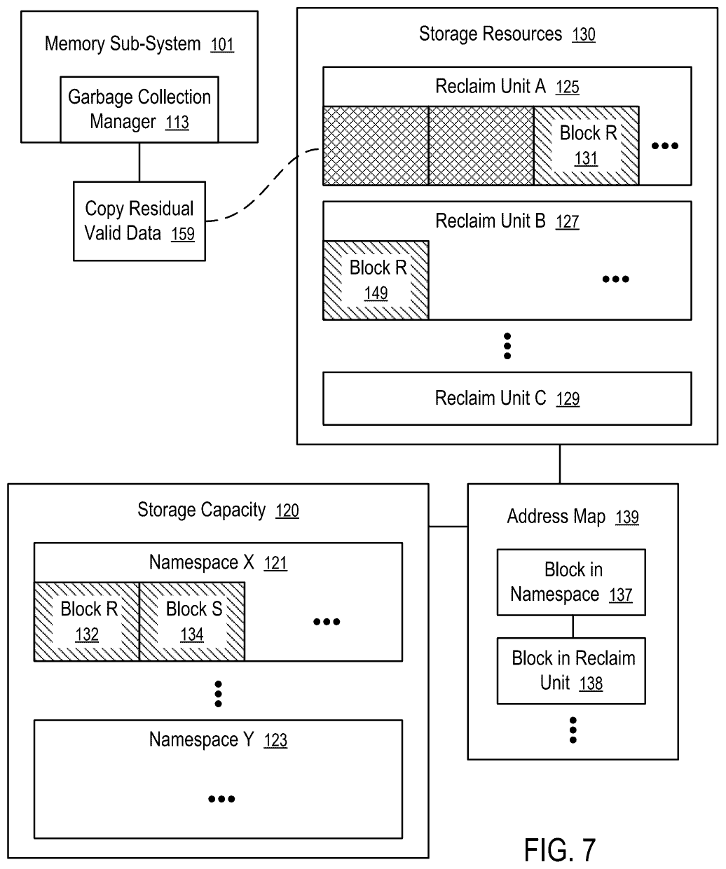

In some instances, the storage space tenant 107 may not be able to invalid all of its data in the blocks 132 and 134 within the specified period of time as requested by the garbage collection manager 113 in the host system 102. Thus, the reclaim unit 125 can have residual valid data to be copied, by the garbage collection manager 113 in the memory sub-system 101, to outside of the victim reclaim unit 125, as illustrated in FIG. 7.

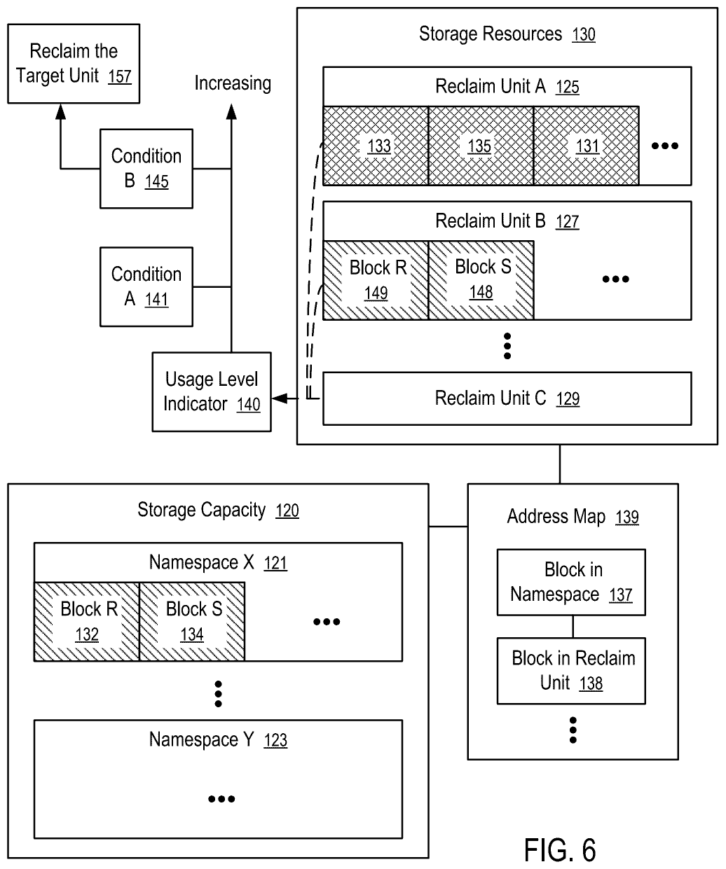

In some instances, the storage space tenant 107 can invalid all of its data in the blocks 132 and 134 within the specified period of time as requested by the garbage collection manager 113 in the host system 102. Thus, the blocks 131, 133, and 135 of storage resources in the memory sub-system 101 can be marked as storing no valid data (and thus can be erased). Subsequently, when the usage level indicator 140 reaches the condition 145 for garbage collection 147, the memory sub-system 101 can erase the reclaim unit 125 without copying data from the blocks 131, 133, 135, as illustrated in FIG. 6.

FIG. 6 shows reclaiming a unit of storage resources in a memory sub-system according to one embodiment.

In FIG. 6, the blocks 131, 133, 135 have no valid data (e.g., after tenant 107 having overwrite 155 new data into blocks 132 and 134 to cause the blocks 132 and 134 of the namespace 121 to have storage resources allocated from another reclaim unit 127). Thus, the garbage collection manager 113 in the memory sub-system 101 can erase the reclaim unit 125 without copying data from the blocks 131, 133, and 135.

In some instances, the operations of host folding 143 can completely evacuate the reclaim unit 125, leaving no valid data in the reclaim unit 125. As a result, the memory sub-system 101 can simply erase the reclaim unit 125 to reclaim 157 the storage resources of the target unit.

In some instances, the operations of host folding 143 can fail to completely evacuate the reclaim unit 125, leaving residual valid data in one or more blocks (e.g., 131) in the reclaim unit 125. Once the condition 145 is reached, the garbage collection manager 113 in the memory sub-system 101 can copy the residual valid data from the reclaim unit 125 to another reclaim unit (e.g., 127) to erase the reclaim unit 125, as illustrated in FIG. 7.

FIG. 7 shows residual garbage collection in a memory sub-system according to one embodiment.

In FIG. 7, after the usage level indicator 140 reaches the condition 145 for garbage collection 147, the garbage collection manager 113 determines that block 131 in the reclaim unit 125 still stores valid data for the block 132 in the namespace 121. To erase the reclaim unit 125 without losing data, the garbage collection manager 113 in the memory sub-system 101 can copy 159 residual valid data from the block 131 of storage resources in the reclaim unit 125 to another reclaim unit (e.g., 127) and update the address map 139 (e.g., to use block 148 in reclaim unit 127 as the storage media of block 132 in the namespace 121, as illustrated in FIG. 6). After no valid data remains in the reclaim unit 125, the garbage collection manager 113 in the memory sub-system 101 can erase the reclaim unit 125 (e.g., in a way similar to what is illustrated in FIG. 6).

Using the techniques of FIG. 2 to FIG. 7, the benefit of write amplification reduction can be maximized without the host system 102 and the memory sub-system 101 racing against each other to perform operations related to garbage collection.

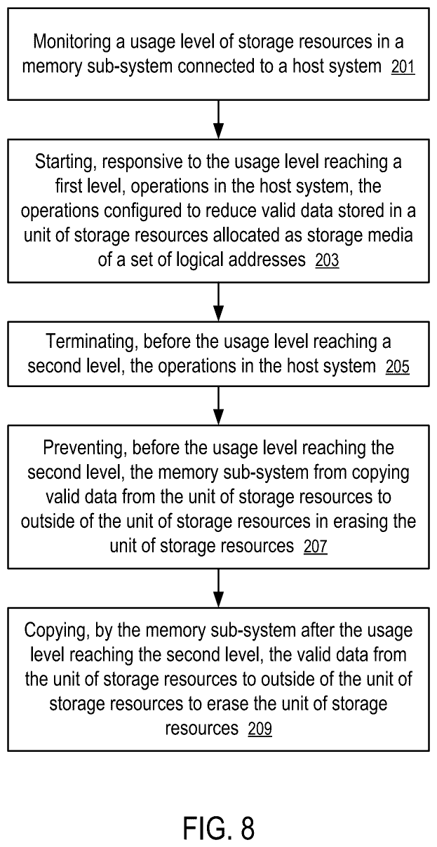

FIG. 8 shows a method to reclaim storage space occupied by proof of space plots in a memory sub-system according to one embodiment. The method of FIG. 8 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 8 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 8 can be implemented using the garbage collection managers 113 of FIG. 1 to perform the operations illustrated in FIG. 2 to FIG. 7.

For example, the storage resources 130 of the memory sub-system 101 can be grouped/organized in the form of reclaim units 125, 127, . . . , 129 that are visible to the host system 102. The host system 102 can use data placement directives specified in write commands sent from the host system 102 to the memory sub-system 101 to control the placement of data to be written into reclaim units 125, 127, . . . , 129.

At block 201, the method of FIG. 8 includes monitoring a usage level of storage resources 130 in a memory sub-system 101 connected to a host system 102.

For example, when a communication protocol supporting flexible direct placement (FDP) is used for the host system 102 to write data into the memory sub-system 101, the host system 102 can evaluate an indicator 140 of the usage level of the storage resources 130 in the memory sub-system 101. The indicator 140 can be evaluated by the host system 102 independently from the memory sub-system 101 monitoring the usage level of its storage resources 130.

At block 203, the method includes starting, responsive to the usage level reaching a first level (e.g., corresponding to a condition 141 associated with a lower threshold or watermark for the usage level of the storage resources 130 in the memory sub-system 101), operations of host folding 143 in the host system 102. The operations of host folding 143 are configured to reduce valid data stored in a unit of storage resources (e.g., a reclaim unit 125) allocated as storage media of a set of logical addresses.

For example, the unit of storage resources can be a reclaim unit in a technique of flexible direct placement.

For example, the host system 102 can determine, based on data placement directives provided by the host system 102 in write commands sent from the host system 102 to the memory sub-system 101, the usage level reaching the first level.

For example, for the operation of host folding 143 in the host system 102, the host system 102 can identify, based on the data placement directives provided by the host system 102 in the write commands sent from the host system 102 to the memory sub-system 101, the set of logical addresses having the unit of storage resources allocated in the memory sub-system 101 as the storage media of the set of logical addresses.

For example, the set of logical addresses can include first logical block addresses (e.g., for blocks 132, 134) in a first namespace (e.g., 121) of a storage capacity 120 of the memory sub-system 101 and second logical block addresses (e.g., of block 136) in a second namespace (e.g., 123) of the storage capacity 120 of the memory sub-system 101. For example, the first logical block addresses (e.g., of the blocks 132, 134) can be non-sequential in the first namespace (e.g., 121).

At block 205, the method includes terminating, before the usage level reaching a second level (e.g., corresponding to a condition 145 associated with a higher threshold or watermark for the usage level of the storage resources 130 in the memory sub-system 101), the operations of host folding 143 in the host system 102.

For example, the host system 102 can determine, based on the data placement directives provided by the host system 102 in the write commands sent from the host system 102 to the memory sub-system 101, the usage level reaching the second level for the termination of the operations of host folding 143 in the host system 102.

In some instances, the operations of host folding 143 complete naturally before the usage level reaching the second level. In other instances, the host system 102 stops the operations of host folding 143 once the usage level approaches, reaches, or exceeds the second level to avoid concurrent efforts in reducing valid data in the unit of storage resources allocated in the memory sub-system 101 as the storage media of the set of logical addresses.

For example, during the operations of host folding 143, a garbage collection manager 113 running in the host system 102 can communicate with storage space tenants (e.g., 107, . . . , 109) running in the host system 102 to reduce valid data stored in the unit of storage resources allocated as storage media of the set of logical addresses.

For example, during the operations of host folding 143, reduction of valid data stored in the unit of storage resources can be via at least one of: a storage space tenant deleting data from a logical address among the set of logical addresses; a storage space tenant deallocating a logical address among the set of logical addresses; and a storage space tenant writing to a logical address among the set of logical addresses.

At block 207, the method includes preventing, before the usage level reaching the second level, the memory sub-system 101 from copying valid data from the unit of storage resources to outside of the unit of storage resources in erasing the unit of storage resources during the operations of garbage collection 147 in the memory sub-system 101.

In one implementation, the host system 102 can send a command to the memory sub-system 101 to instruct the memory sub-system 101 to pause garbage collection 147 in general, or to pause garbage collection 147 of the unit of storage resources (e.g., reclaim unit 125) specifically. In another implementation, the garbage collection manager 113 in the firmware of the memory sub-system 101 is configured to refrain from performing garbage collection 147 in general before usage level reaching the second level.

At block 209, the method includes copying, by the memory sub-system 101 after the usage level reaching the second level, the valid data from the unit of storage resources to outside of the unit of storage resources to erase the unit of storage resources. After the copying, the memory sub-system 101 can erase the unit of storage resources (e.g., reclaim unit 125) so that the storage resources in the erased unit can be programmed again to store new data provided by the host system 101 via write commands.

For example, after the usage level reaching the second level, the memory sub-system 101 can determine whether there is residual valid data in the unit of storage resources and, if so, copy the residual valid data from the unit of storage resources to outside of the unit of storage resources to erase the unit of storage resources.

It can be advantageous to arrange sequential executions of host folding 143 and garbage collection 147 at appropriate time instances with no or minimal communications outside of storage access protocols of flexible direct placement (FDP). To arrange the sequential executions, the garbage collection managers 113 in the memory sub-system 101 and in the host system 102 can be configured to separately and independently monitor the indicator 140 of usage level according to information available to the memory sub-system 101 and the host system 102 respectively. The garbage collection manager 113 in the memory sub-system 101 can be configured to start its garbage collection 147 according to a statistically determined condition 145 to avoid performance degradation due to the lack of sufficient free storage resources ready for programming. Separately and independently, the garbage collection manager 113 in the host system 102 can start its host folding 143 according to another statistically determined condition 141 to best harvest the benefit of write amplification reduction with least disturbance to other tasks.

In general, host folding 143 can start any time before garbage collection 147 starts in the memory sub-system 101. However, starting host folding 143 too soon can disturb the normal executions of the storage space tenants 107, . . . , 109 without added benefit in write amplification reduction. On the other hand, if starting host folding 143 too late, the storage space tenants 107, . . . , 109 may not have sufficient time to perform operations to reduce the valid data in a victim reclaim unit.

To maximize the benefit of write amplification reduction and reduce impacts of host folding 143, it can be desirable to delay the onset of host folding 143 to a point that still provides a sufficient time period for host folding 143 to maximize the invalidation of data stored in a victim reclaim unit within a reasonable time window. The time window can be adjusted via testing the cost and benefit of starting host folding 143 under different conditions and determining a statistically optimized window between the conditions 145 and 141 from the test results.

Based on the data placement directive used by the host system 102 to instruct the memory sub-system 101 to place data into reclaim units, the garbage collection manager 113 in the host system 102 can have sufficient information to determine an indicator 140 of the usage level of reclaim units 125, 127, . . . , 129 in the memory sub-system 101 without assistance/communications from the memory sub-system 101.

For example, reclaim unit usage in the memory sub-system 101 can be estimated by the host system 102 as a ratio between the number of free reclaim units available in the memory sub-system 101 and the total number of reclaim units available in the data storage. The total number of reclaim units available in the data storage can be determined or estimated based on the storage capacity 120 of the memory sub-system 101 and the storage capacity of one reclaim unit in the memory sub-system 101. When the host system 102 writes to the memory sub-system 101 an amount of data that is equal to the storage capacity of one reclaim unit, the host system 102 can decrease the count of free reclaim units by one (and thus increase the count of in-use reclaim units by one). After the host system 103 performs host folding 143 to reduce or evacuate a victim reclaim unit, the host system 102 can assume that the victim reclaim unit can be reclaimed by the garage collection manager 113 in the memory sub-system 101 when a free reclaim unit is needed; and thus, the host system 102 can increase the count of free reclaim units by one (and thus decrease the count of reclaim units in use by one). Thus, the host system 102 can determine the indicator 140 of usage level of reclaim units with sufficient accuracy without assistance from the memory sub-system 101.

For improved accuracy, the host system 103 can track the size of the residual valid data remaining in the victim reclaim unit and count the size as new data written into the memory sub-system, since the memory sub-system 101 is to copy the residual valid data during garbage collection 107. Alternatively, the host system 103 can send read commands to retrieve the residual valid data and write commands to save the valid data at another reclaim unit having data of similar life, which has an effect similar to the memory sub-system 101 copying the data during garbage collection 147.

Optionally, the host system 101 can track the indicator 140 of the usage level of reclaim units in the memory sub-system as a radio between the number of total free capacity in reclaim units in the memory sub-system 101, and the total storage capacity 120 of the reclaim units 125, 127, . . . , 129 in the memory sub-system 101.

In general, different types of indicators (e.g., 140) of the usage level of storage resources 130 in the memory sub-system 101 can be monitored for the triggering of host folding 143. Since it is not necessary to trigger host folding 143 at a precision instance, the accuracy requirement for the indicator 140 used to trigger the host folding is not high. Thus, the host system 140 can use an indicator that is easy to track and compute.

With minimal communications outside of flexible direct placement (FDP), garbage collection managers 113 in the host system 102 and in the memory sub-system 101 can separately and independently monitor the usage level of the reclaim units (and even use different types/definitions of usage level indicators).

The garbage collection manager 113 in the memory sub-system 101 can be configured to skip garbage collection before its monitored reclaim unit usage level reaches a condition 145 that triggers garbage collection 147 in the memory sub-system 101.

The garbage collection manager 113 in the host system 102 can be configured to separately monitor the reclaim unit usage level based on write commands sent from the host system 102 to the memory sub-system 101, without additional communications outside of the protocol of flexible direct placement (FDP).

In one implementation, a statistically determined margin from the condition 145 is used to select the condition 141 used in the host system 101 to trigger host folding 143.

During host folding 143, the garbage collection manager 113 in the host system 102 communicates with storage space tenants 107, . . . , 109 to promote the expiration of data stored in one or more victim reclaim units identified by the host system 102. For example, a storage space tenant 107 or 109 can be a user process spawned by an application running in the host system 102 (or another computing device that accesses the host system 102 to use the storage space controlled by the host system 102 over a computer network). For example, a storage space tenant 107 or 109 can be a kernel process spawned by an operating system running in the host system 102, or a thread spawned by a process for execution on a core of a central processing unit (CPU), etc.

It takes a period of time for the host folding 143 to invalid a significant amount of valid data remaining in one or more victim reclaim units. For example, it may take minutes for the storage space tenants (e.g., 107 or 109) to complete operations that invalidate the remaining data in the victim reclaim units; and during such a time period, the memory sub-system 101 can receive and/or process thousands or millions storage access requests, depending on the current operating condition of the host system. Thus, the amount of data that may be written during the time period between the conditions 141 and 145 can have large statistical variations.

In general, the margin from the condition 145 of triggering garbage collection 147 to the condition 141 for triggering host folding 143 can be selected to balance the need to avoid unnecessary operations of host folding 143, and the benefit of maximized data invalidation in the victim reclaim units. Due to the large statistical variations in the amount of data that may be written into the memory sub-system after the triggering of host folding, a margin that is statistically most likely to allow host folding 143 to complete naturally can be used to set the condition 141 for triggering host folding 143.

For example, a data center may tweak the margin to minimize a function of costs associated with folding and costs associated with write amplification resulting from garbage collection to determine an optimize the margin for a type of applications running using the storage space of the memory sub-system 101.

For example, the margin can be dependent on a current pattern of activities of the storage space tenants (e.g., 127, . . . , 129), in view of different pairs of activity pattern and statistically optimized margins recognized from historic records of host folding 143 performed in the past.

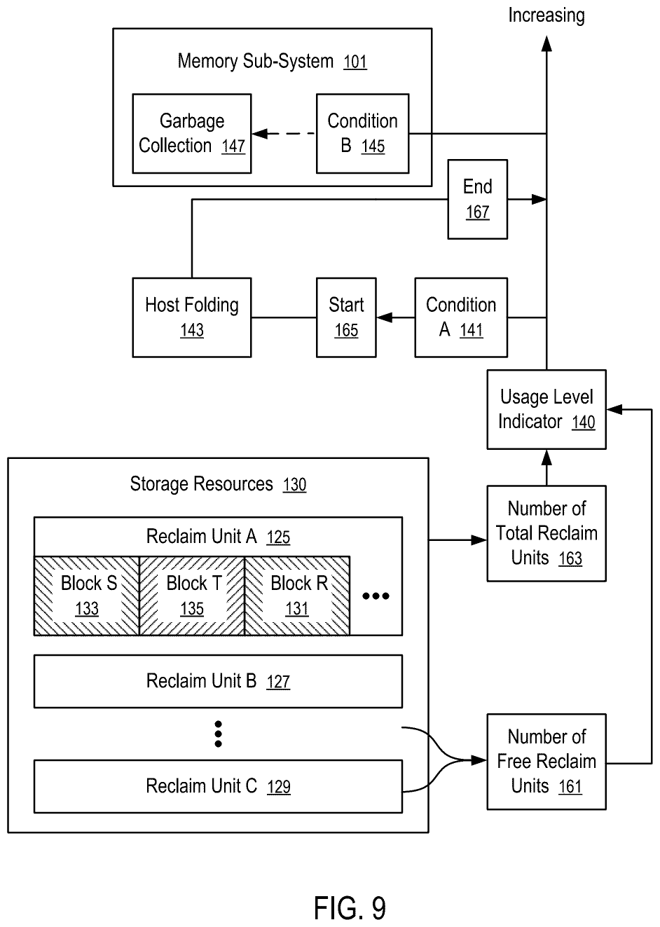

FIG. 9 shows a technique to schedule operations of a host system to reduce garbage collection in a memory sub-system with minimal or no communications outside of storage access protocol for flexible direct placement according to one embodiment. For example, the operations of host folding 143 of FIG. 2 to FIG. 5 can be implemented using the technique of FIG. 9.

In FIG. 9, the garbage collection managers 113 in the host system 102 and the memory sub-system 101 are separately configured to avoid the need to communicate outside of storage access protocol for flexible direct placement (FDP).

For example, the garbage collection manager 113 in the memory sub-system 101 can monitor an indicator 140 of usage level of reclaim units 125, 127, . . . , 129 to trigger operations of garbage collection 147.

Independently from the memory sub-system 101 monitoring the indicator 140 of usage level of reclaim units 125, 127, . . . , 129, the garbage collection manager 113 in the host system 102 can monitor a version of the indicator 140 based on information readily available to the host system 102 (e.g., based on write communicates made using the storage access protocol for flexible direct placement (FDP)).

For example, the host system 102 can count the number 161 of free reclaim units in the memory sub-system 101 based on the amount of data written by the host system 102 into the memory sub-system 101, since the storage size of one reclaim unit in the memory sub-system 101 is known to the host system 102. For example, when an amount of new data is written into the memory sub-system 101, the number 161 of free reclaim units in the memory sub-system 101 can be reduced by the amount divided by the storage size of one reclaim unit. Based on the number 163 of total reclaim units in the memory sub-system 101 and the number 161 of free reclaim units 161 in the memory sub-system 101, the garbage collection manager 113 in the host system 102 can compute the indicator 104 without communications performed outside of storage access protocol for flexible direct placement (FDP).

After the condition 141 is set for the garbage collection manager 113 in the host system 102, the garbage collection manager 113 can start 165 the operations of host folding 143 when the indicator 140 satisfies the condition 141. The condition 141 can be selected such that the operations of host folding 143 end 167 before the indicator 140 reaches the condition 145 in most instances statistically.

Optionally, the condition 145 is specified for the garbage collection manager 113 in the host system 102 such that host folding 143 can occasionally fail to complete before the indicator 140 reaching the condition 145; and the garbage collection manager 113 in the host system can be configured to terminate the operations of host folding 143 upon the indicator 140 reaching the condition 145.

In some implementations, after the end 167 of host folding 143, the garbage collection manager 113 in the host system 102 can assume that the memory sub-system 101 will erase the victim reclaim units and thus increase the number 161 of free reclaim units by the number of the victim reclaim units being invalidated during host folding 143.

Optionally, the host system 102 can be configured to completely invalidate data in a victim reclaim unit to allow the memory sub-system 101 to erase the victim reclaim unit without garbage collection for the victim reclaim unit (e.g., there is no residual valid data remaining in the victim reclaim unit after host folding 143).

For example, when a storage data tenant (e.g., 107 or 109) determines that the data in a block 132 in a namespace 121 currently storing in a block 133 of the victim reclaim unit 125 is needed for a period of time that is expected to extend beyond a time instance where the indicator 140 reaches the condition 145 for garbage collection 147, the garbage collection manager 113 in the host system 102 can be configured to read the data from the block 132 in the namespace 121 and overwrite 155 the block 132 with the retrieved data using a reclaim unit handle to cause the block 133 to be invalidated in the victim reclaim unit 125 (e.g., in a way similar to that illustrated in FIG. 5). The reclaim unit handle can be selected to group the retrieved data with other data having similar life for storing in another reclaim unit 127. Such an operation of overwrite 155 can increase write amplification for the data stored in the block 132 in the namespace 121 in a way similar to the copying 159 of residual valid data during garbage collection 147. However, since the host system 102 can arrange the data to be stored into another reclaim unit with other data having similar life, while the garbage collection manager 113 does not have such information about estimated life of data, such an operation of overwrite 155 by the host system 102 can be advantageous in reducing further write amplification associated with the data stored in the block 132 in the namespace 121.

Alternatively, such an overwrite 155 performed by the garbage collection manager 113 in the host system 102 can be skipped (e.g., to avoid the need to communicate the retrieved data to the host system 102 and back to the memory sub-system 101 for improved performance); and the residual valid data 159 can be copied by the garbage collection manager 113 in the memory sub-system 101 during the operation of garbage collection 147. In some implementations, the garbage collection manager 113 in the host system 102 can selectively skip such an overwrite 155 based on the current operating condition (e.g., whether there is a need to skip the read and write communications over a connection to the memory sub-system 103 to save communications bandwidth, to save power, etc.).

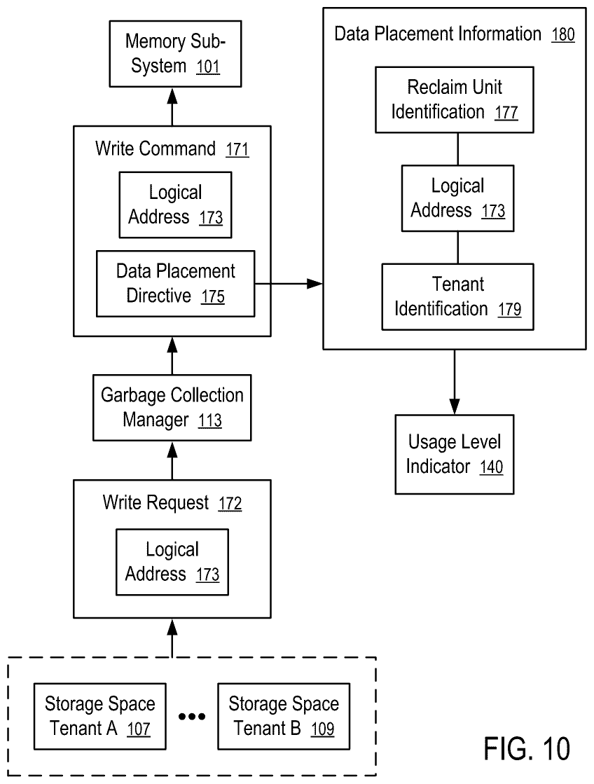

FIG. 10 shows a technique of tracking data placement information in a host system to facilitate operations of host folding according to one embodiment. For example, the operations of host folding 143 in FIG. 2 to FIG. 5 can be performed using the data placement information 180 in FIG. 10 with no communications outside of the storage access protocol for flexible direct placement according to one embodiment.

In FIG. 10, a garbage collection manager 113 running in a host system (e.g., 102 in a computing system 100 of FIG. 1) can be configured to send write commands (e.g., 171) to a memory sub-system 101 on behalf of storage space tenants 107, . . . , 109.

For example, when a storage tenant (e.g., 107 or 109) is to write a block of data to a logical address 173, the garbage collection manager 113 in the host system 102 can generate a write command 171 having a data placement directive 175 that causes the memory sub-system 101 to place the data of the write request 172 at a reclaim unit that stores data of similar life (e.g., for erasure at about the same time).

For example, the garbage collection manager 113 in the host system 102 can communicate with the storage space tenants 107, . . . , and 109 to determine an estimate time to the erasure of the data provided by the respective tenants 107, . . . , and 109. The garbage collection manager 113 can use a same reclaim unit handle to write data of similar time frame for erasure/expiration, which can cause the memory sub-system 101 to place the data on a same reclaim unit or a same group of reclaim units.

Alternatively, the garbage collection manager 113 can assign reclaim unit handles to the tenants 107, . . . , and 109 to allow the tenants 107, . . . , and 109 to generate write commands (e.g., 171) to the memory sub-system 101. Tenants 107, . . . , and 109 having similar data life cycles can be assigned to use a same reclaim unit handle.

In some implementations, the garbage collection manager 113 in the host system 102 can track historic data of life cycles of data of different types of tenants 107, . . . , 109 to group data onto reclaim units.

Based on the data placement directive (e.g., 175) used in the write commands (e.g., 171) sent to the memory sub-system 101, the garbage collection manager 113 in the host system 102 can track the data placement information 180.

For example, the data placement information 180 can track a set of logical addresses (e.g., 173) that have data written into a same reclaim unit (or a same group of reclaim units) represented by a reclaim unit identification 171. Further, the data placement information 180 can track which logical addresses (e.g., 173) are used by which tenant (e.g., represented by a tenant identification 179) so that the garbage collection manager 113 can contact the respective tenants during host folding 143.

Based on the data placement information 180, the garbage collection manager 113 in the host system 102 can compute an indicator 140 of usage level of reclaim units. For example, the garbage collection manager 113 can count the number of reclaim unit identifications 177 that is associated with at least one logical address 173 logical and use the count as the number of reclaim units that are not free in the memory sub-system 101. Alternatively, the garbage collection manager 113 can determine the indicator 140 in a way as discussed above in connection with FIG. 9.

When the usage level indicator 140 meets the condition 141 for host folding 143, the garbage collection manager 113 in the host system 102 can select a reclaim unit identification (e.g., 177) that has a set of logical addresses (e.g., 173) storing data that are about to expire. For example, the garbage collection manager 113 in the host system 102 can identify a set of reclaim unit identifications (e.g., 177) having data that is closest to expiration; and from such reclaim unit identifications (e.g., 177), the host system 102 can select, as victim reclaim units, one or more reclaim unit identifications that have the fewest associated logical addresses (e.g., 173) that store valid data. The garbage collection manager 113 can then communicate with the respective tenants, represented by the tenant identifications (e.g., 179) associated with the remaining logical addresses (e.g., 173) of the victim reclaim units to cause the respective tenants to deallocate 153 or erase data from the remaining logical addresses, or to overwrite 155 data to the remaining logical addresses (e.g., 173) of the victim reclaim units. Optionally, the garbage collection manager 113 can retrieve data from some of the remaining logical addresses (e.g., 173) and write the data back to respective logical addresses to cause the memory sub-system 101 to store the data to one or more other reclaim units.

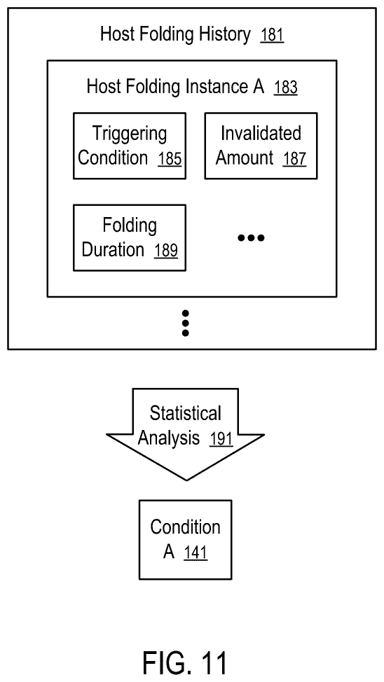

FIG. 11 shows a statistical analysis of history data of host folding to determine a condition to trigger host folding according to one embodiment. For example, the condition 141 to trigger host folding 143 in FIG. 2 to FIG. 5 can be established via the statistical analysis 191 in FIG. 11.

The garbage collection manager 113 in the host system 102 can be configured to collect data recording host folding history 181. When host folding 143 is triggered according to a triggering condition 185, the garbage collection manager 113 in the host system 102 can record data about the host folding instance 183. The recorded data for the instance 183 can include the triggering condition 185, the amount 187 of data that is stored in one or more victim reclaim unit and is invalidated during the instance of host folding 143, the duration 189 of the operations of host folding 143 in the instance 183, and other data, such as the time gap between completion of host folding 143 and the usage level indicator 140 reaching the condition 145 for garbage collection 147, etc.

After data about a plurality of host folding instances (e.g., 183) is recorded, a statistical analysis 191 can be performed (e.g., by the garbage collection manager 113 in the host system 102, or another computing device) to identify a condition 141 where the probability of host folding 189 completing before the indicator 140 reaching the condition 145 for garbage collection 147 is above a threshold.

Optionally, a cost function can be used to penalize the time gap between completion of host folding 143 and the usage level indicator 140 reaching the condition 145 for garbage collection 147. The cost function can further reward the invalidated amount (e.g., 187). The cost function can be minimized against the host folding history 181 to gradually reaching a statistically optimized condition 141 for the computing system 100.

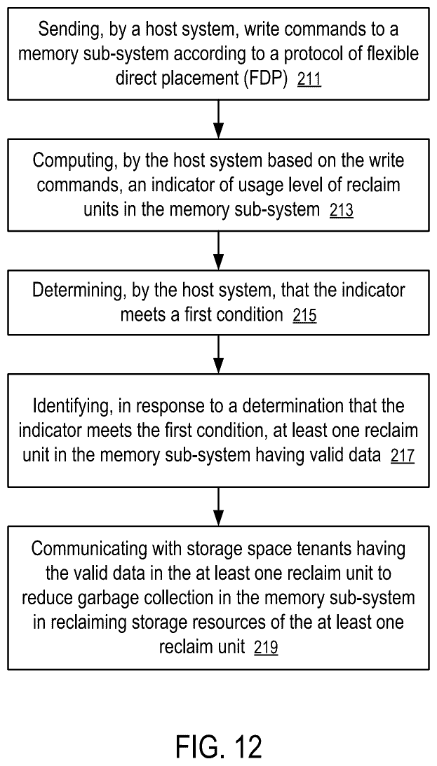

FIG. 12 shows a method to schedule operations of a host system to reduce garbage collection in a memory sub-system with minimal or no communications outside of storage access protocol for flexible direct placement according to one embodiment. The method of FIG. 12 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 12 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 12 can be implemented using the garbage collection managers 113 of FIG. 1 to perform the operations discussed in connection with FIG. 2 to FIG. 11.

For example, the method of FIG. 12 can be used in connection with the method of FIG. 8.

At block 211, the method of FIG. 12 includes sending, by a host system 102, write commands (e.g., 171) to a memory sub-system 101 according to a protocol of flexible direct placement (FDP). For example, the write commands (e.g., 171) can be sent in a way as discussed above in connection with FIG. 10.

At block 213, the method includes computing, by the host system based on the write commands, an indicator 140 of usage level of reclaim units 125, 127, . . . , 129 in the memory sub-system 101.

For example, the indicator can be representative of a ratio between a count of free reclaim units in the memory sub-system and a total count of reclaim units in the memory sub-system as discussed above in connection with FIG. 9.

For example, the garbage collection manager 113 running in the host system 102 can be programmed to decrease the count of free reclaim units by one for an amount of data being written into the memory sub-system 101 where the amount is equal to a storage capacity of one reclaim unit.

At block 215, the method includes determining, by the host system 102, that the indicator 140 meets a first condition 141.

At block 217, the method includes identifying, in response to a determination that the indicator 140 meets the first condition 141, at least one reclaim unit (e.g., 125) in the memory sub-system 101 having valid data.

For example, the identification of the at least one reclaim unit (e.g., 125) as victim reclaim units targeted for host folding 143 can be based on data placement information 180 tracked according to the data placement directive 175 in write commands (e.g., 171) sent from the host system 102 to the memory sub-system 101.

At block 219, the method includes communicating (e.g., by the garbage collection manager 113 running in the host system 102) with storage space tenants 107, . . . , 109 having the valid data in the at least one reclaim unit (e.g., 125) to reduce garbage collection 147 in the memory sub-system 101 in reclaiming storage resources of the at least one reclaim unit (e.g., 125).

For example, the communicating in block 219 can cause the storage space tenants 107, . . . , 109 to delete data from, overwrite data at, or deallocate the logical addresses that have valid data stored in the at least one reclaim unit (e.g., 125), as illustrated in FIG. 4 and FIG. 5.

For example, the garbage collection manager 113 running in the host system 102 can be programmed to increase the count of free reclaim units by a count of the at least one reclaim unit after the communicating to perform host folding 143.

For example, the garbage collection manager 113 running in the host system 102 can be programmed to: determine a life of data stored at a logical address and in the at least one reclaim unit (e.g., via communicating with the respective storage tenants/owners of the data); retrieve the data from the logical address (e.g., via sending read commands to the memory sub-system 101); select, based on the life, a reclaim unit handle of the memory sub-system (e.g., to group the data with other data having similar life); and write the data back to the logical address using the reclaim unit handle to cause the memory sub-system 101 to re-place the date of the logical address at a different reclaim unit that stores other data having life similar to the life determined for the data storage at the logical address.

The method of FIG. 12 can be performed without communications between the host system 102 and the memory sub-system 101 outside of the protocol of flexible direct placement. For example, it is not necessary to introduce a new command into an existing standard protocol for communications between host systems (e.g., 102) and memory sub-system 101 that supports flexible direct placement. For example, it is not necessary to introduce additional communications beyond what is the typical usages of the existing standard protocol, such as a standard for a nonvolatile memory express (NVMe) protocol.

For example, the memory sub-system 101 is configured, separately from the configuring of the host system 102, to be prevented (e.g., via a configuration of a firmware of the memory sub-system 101) from performing garbage collection before the indicator meets a second condition. For example, the first condition can be selected based on the second condition to allow the communicating to complete before the indicator changes to meet the second condition.

For example, the first condition is selected based on a statistical analysis 191 of historic data (e.g., history 181) recording operations of host folding 143 performed by the host system 101 in reducing valid data in reclaim units 125, 127, . . . , 129 in the memory sub-system 101.

Optionally, the garbage collection manager 113 running in the host system 102 can be programmed to store data grouping logical addresses (e.g., 173) having valid data stored in a reclaim unit (e.g., represented by a reclaim unit identification 177) and store data identifying identities (e.g., tenant identification 179) of storage space tenants (e.g., 107, . . . , 109) of the logical addresses (e.g., 173), as illustrated in FIG. 10.

In some implementations, a memory sub-system (e.g., 101 in FIG. 1) is configured to provide information to a host system (e.g., 102 in FIG. 1) to coordinate their operations related to garbage collection 147.

For example, instead of the host system 102 tracking (e.g., based on write commands (e.g., 171) sent from the host system 102 to the memory sub-system 101) the indicator 140 of the usage level of storage resources in the memory sub-system 101, the memory sub-system 101 can evaluate and provide the indicator 140 in a log page for the host system 102 to read.

Existing protocols for communications between host systems and memory sub-systems (e.g., NVMe protocols) allow a host system to retrieve a log page from a memory sub-system. Examples of such log pages include a log page for health information, a log page for error information, and a log page for vendor specific information. The existing log mechanisms can be augmented or extended to include information related to garbage collection, such as the indicator 140 of the usage level of storage resources in the memory sub-system 101.

For example, the memory sub-system 101 can be configured to monitor the usage level indicator 140 in determining whether to start its operations of garbage collection 147. Before the indicator 140 reaches the condition 145 for garbage collection, the memory sub-system 101 can identify (e.g., periodically) in a log page, the current usage level of storage resources according to the monitored usage level indicator 140.

The host system 102 can read (e.g., periodically) the log page to retrieve the most recent usage level as logged according to the indicator 140 evaluated by the memory sub-system 101. Based on the usage level identified in the retrieved log page, the host system 102 can determine whether to start host folding 143.

Optionally, the host system 102 can be configured to monitor the changes in the log page over a period of time to determine a statistically optimized condition 141 for triggering the host folding 143.

For example, the host system 102 can observe the changes of the usage level specified in the log page over a period of time to determine the condition 145 that causes the memory sub-system 101 to start garbage collection 147. Further, the host system 102 can determine/estimate how long it takes for the usage level identified in the log page in the memory sub-system 101 to change from any given condition to the condition 145 corresponding to the onset of garbage collection 147. Based on the statics analysis, the host system 102 can predict a statistically optimized condition (e.g., 141) for the current pattern of the workload of the memory sub-system, such that when host folding 143 can start just in time for maximized folding benefits, while the impact from host folding 143 is minimized.

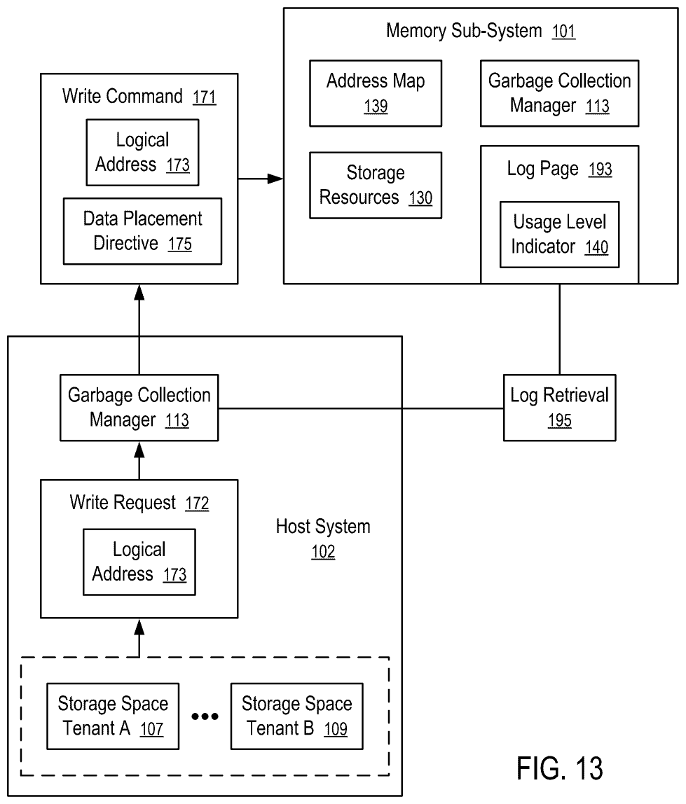

FIG. 13 shows an example of a memory sub-system providing information via a log page to a host system to assist the host system in scheduling operations related to garbage collection in the memory sub-system according to one embodiment. For example, the operations of host folding 143 of FIG. 2 to FIG. 5 can be implemented using the technique of FIG. 13.

In FIG. 13, the host system 102 sends write command (e.g., 171) to a memory sub-system 101 to store data of storage space tenants 107, . . . , 109 in a way similar to that illustrated in FIG. 10. In FIG. 10, the host system 102 tracks data placement information 180 based on the data placement directives (e.g., 175) provided in the write commands (e.g., 171); and the data placement information 180 can be used by the garbage collection manager 113 in the host system 102 to evaluate the indicator 140 of usage level of reclaim units in the memory sub-system 101.

Alternatively, or in combination, the host system 102 in FIG. 13 can perform an operation of log retrieval 195 to obtain, from a log page 193 in the memory sub-system 101, information relevant to the garbage collection 147 in the memory sub-system 101.

For example, the garbage collection manager 113 in the memory sub-system 101 can evaluate its version of the indicator 140 of usage level of storage resources 130. The garbage collection manager 113 in the memory sub-system 101 determines whether to start garbage collection 147 based on its evaluated indicator 140. Further, the garbage collection manager 113 in the memory sub-system 101 can record its evaluated indicator 140 in a log page 193 for retrieval 195 by the host system.

For example, the log page 193 can be configured primarily for health information, or error information, or vendor specific information and augmented to further provide garbage collection related information. Alternatively, the log page 193 can be separate from the log page for health information, the log page for error information, and the log page for vendor specific information.

In one implementation, the indicator 140 of usage level of storage resources 130 evaluated by the garbage collection manager 113 in the memory sub-system 101 has the same definition as the indicator 140 that can be evaluated by the host system 102 (e.g., the indicator 140 evaluated by the host system 102 based on the data placement information 180 tracked by the host system 102 based on the data placement directives 175 as in FIG. 10). The availability of the indicator 140 in the log page 193 allows the host system 102 to skip evaluating its version of the indicator 140.

In other implementations, the indicator 140 of usage level of storage resources 130 evaluated by the garbage collection manager 113 in the memory sub-system 101 can be based on further information not available to the host system 102. Even with the use of the technology of flexible direct placement (FDP), the memory sub-system 101 has more information about the usages of the storage resources 130 than the host system 102. Thus, in general, the usage level indicator 140 evaluated by the memory sub-system 101 can be more accurate and/or more update to date than an indicator 140 evaluated by the host system 101.

The host system 102 can use the indicator 140 retrieved from the log page 193 in the memory sub-system 101 to determine whether to start host folding 143 (e.g., whether the indicator 140 meets the condition 141), without separately evaluating a version of the indicator 140 (e.g., based on data placement information 180 as in FIG. 10). Alternatively, the host system 102 uses the indicator 140 evaluated based on data placement information 180 to determine whether the indicator 140 is sufficiently close to the condition 141 (e.g., within a predetermined range from the condition 141); and if so, the host system 102 obtains, through log retrieval 195, a more accurate version of the indicator from the log page 193 in the memory sub-system 101. For example, the frequency of log retrieval 195 can increase when the indicator 140 evaluated by the host system 102 is close to the condition 141 for host folding 143; and the host system 102 can decrease the frequency of log retrieval 195 when the indicator 140 evaluated by the host system 102 is more than a range away from satisfying the condition 141.

Optionally, the garbage collection manager 113 in the host system 102 can be configured to use a set of historic records of usage level indicators (e.g., 140) retrieved from the log page 193 to establish an empirical mapping between a version of the indicator 140 of usage level of reclaim units evaluated by the host system 102 and the indicator 140 evaluated by the memory sub-system 101 in the log page 193.

For example, the host system 102 can evaluate an indicator 140 using a technique as discussed above in connection with FIG. 9 or FIG. 10. Substantially at the same time, the host system 102 can perform the log retrieval 195 to obtain the corresponding indicator 140 evaluated by the memory sub-system 101 at a time that is close to host system 102 evaluating the indicator 104. The pair of indicators, evaluated by the host system 102 and the memory sub-system 101, can be stored to indicate the relation between the indicators 140 evaluated by the host system 120 and the memory sub-system 101. After collecting a plurality of indicator pairs, the host system 102 can establish an statistical/empirical mapping between the indicator 140 evaluated by the host system 102 and the indicator 140 evaluated by the memory sub-system 101.

For example, using the statistical/empirical mapping, the garbage collection manager 113 in the host system 102 can predict the indicator 140 in the memory sub-system 101 (e.g., to reduce the frequency of reading the log page 193 in the memory sub-system 101).

For example, using the statistical/empirical mapping the garbage collection manager 113 in the host system 102 can predict the indicator 140 that can be evaluated from the data placement directives (e.g., 175) based on the indicator 140 from the log page 193 without tracking the data placement information 180.

For example, using the statistical/empirical mapping the garbage collection manager 113 in the host system 102 can predict the indicator 140 in the log page 193 based on indicator 140 evaluated from the data placement directives (e.g., 175) without performing the log retrieval 195.

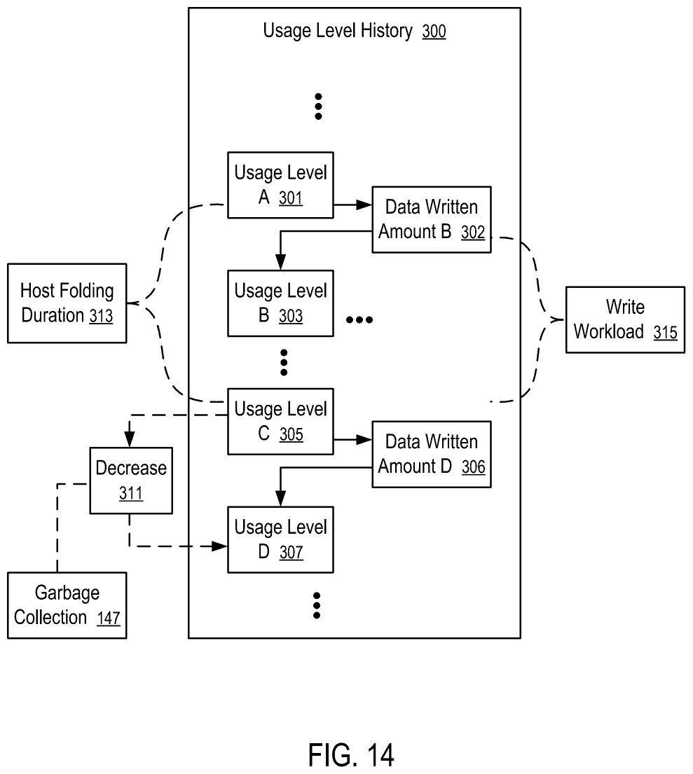

FIG. 14 shows a technique for a host system to schedule operations related to garbage collection in a memory sub-system according to one embodiment. For example, the technique of FIG. 14 can be implemented in a computing device 100 of FIG. 1 using a log page 193 illustrated in FIG. 13.

In FIG. 14, the garbage collection manager 113 in the host system 102 is configured to track a usage level history 300 for a period of time.

For example, at a time instance, the host system 102 can perform an operation of log retrieval 195 (e.g., as in FIG. 13) to determine, from a log page 193, an indicator 140 of usage level of storage resources 130 determined by the memory sub-system 101. The indicator 140 retrieved from the log page 193 identifies a usage level 301 that can be recorded in the history 300 with a timestamp of the log page 193. Subsequently, after the host system 102 sends write commands (e.g., 171) to have an amount 302 of data written into the memory sub-system 101, the host system 102 can read the log page 193 again to determine the next usage level 303 with the corresponding timestamp of the retrieved log page 193. After reading the log page 193 a number of times, the host system 102 can detect an instance where the current usage level 307 as reported in the log page 139 decreases 311 from a prior usage level 305 reported in the log page 139, which indicates that an operation of garbage collection 147 has been performed between the reads of the log page 193 to obtain the usage levels 305 and 307, during which an amount 306 of data has been written into the memory sub-system 101.

Based on the usage level history 300, the host system 102 can estimate that the memory sub-system 101 is to perform garbage collection 147 after the indicator 140 reported in the log file 193 reaches the usage level 305. Thus, the host system 102 can schedule host folding 143 at a time that is the duration 313 of host folding 143 before the log page 193 reports the usage level 305.

For example, based on the timestamps of the usage levels (e.g., 301, . . . , 305) obtained from the log file 193, the host system 102 can identify an earlier usage level 301 such that the time gap between the reads of the log file 193 for usage levels 301 and 305 is approximately the same as (e.g., closest to) the predicted or pre-scheduled duration 313 for completion of the operations of host folding 143. Subsequently, the host system 102 can use the usage level 301 for a condition 141 to trigger host folding 143.

For example, when the indicator 140 retrieved from the log file 193 approaches or reaches the usage level 301 (or within a predetermined range from the usage level 301), the host system 102 can start its operations of host folding 143.

The sum of the amounts (e.g., 302, . . . ) of data written to the memory sub-system 101 between the usage levels 301 to 305 represents the write workload 315 that can cause the indicator 140 in the log file 193 to increase from the usage level 301 to the usage level 305. The write workload 315 is more accurate in prediction whether the usage level 305 will be reached after the duration 313.

When the host system 102 sends write commands at a higher speed, the time to process the same workload 315 can be reduced. When the host system 102 sends write commands at a lower speed, the time to process the same workload 315 can be reduced.

The usage level 301, identified based on the time duration between the reads of the log page to obtain the usage levels 301 and 305 being equal to the duration 313 of host folding 143, is suitable for trigger host folding 143 when the memory sub-system 101 has a rate of write commands corresponding to write workload 315 divided by the duration 313.

When the average speed of write commands sent from the host system 102 to the memory sub-system 101 changes, the time for the indicator 140 in the log page 195 to complete processing the same workload 315 can change. Thus, the usage level (e.g., 301) used for the condition 141 to trigger host system 102 can be adjusted accordingly.

For example, when the host system 102 is expected to send write commands at a slower rate to the memory sub-system 101, the processing the same workload 315 in the memory sub-system 101 can take a longer time. Thus, the host folding 143 can have more time to complete before reaching the level for the garbage collection 147. Therefore, a higher usage level (e.g., 303) can be used to schedule the host folding 143 more closer to the time of garbage collection 147.

For example, when the host system 102 is expected to send write commands at a higher rate to the memory sub-system 101, the processing the same workload 315 in the memory sub-system 101 can take a shorter time. To complete host folding 143 in the during 313 before the usage of storage resources in the memory sub-system 101 reaches the level for garbage collection 147, the host system 102 is to start host folding earlier (e.g., using a lower usage level to schedule the host folding 143 can provide sufficient time for host folding 143 to complete before garbage collection 147).

In some implementations, the usage level history 300 includes multiple scenarios of the host system 102 sending write commands at different speeds to the memory sub-system 101 to reach garbage collection 147. From the history 300, a plurality of usages levels (e.g., 301) can be identified from writing data to the memory sub-system 101 at different average speeds. Thus, the garbage collection manager 113 in the host system 102 can use a condition 141 corresponding to the current speed of write data to the memory sub-system 101 to select a usage level for triggering host folding 143.

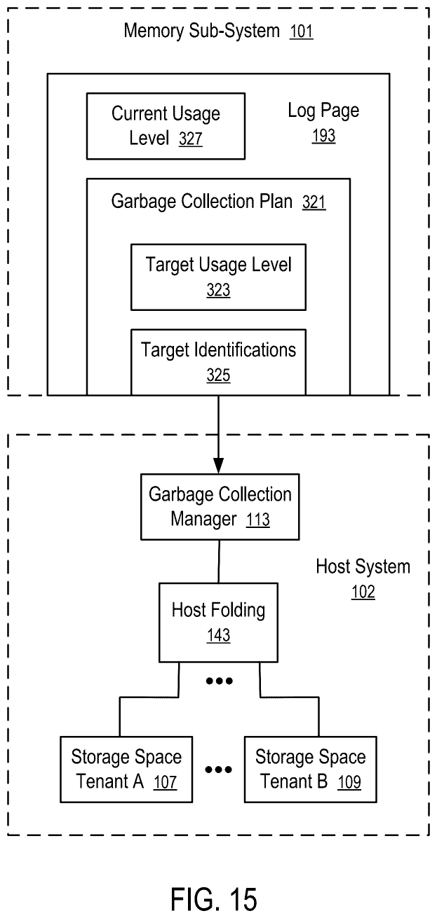

Optionally, the memory sub-system 101 provides in the log page 193 not only the usage level indicator 140, but also other information that can be used by the garbage collection manager 113 in the host system 102, as illustrated in FIG. 15.

FIG. 15 illustrates a log page provided from a memory sub-system to coordinate operations of a host system related to garbage collection in the memory sub-system according to one embodiment.

In FIG. 15, the log page 193 generated in the memory sub-system 101 identifies a current usage level 327, representative of the indicator 140 of usage level of storage resources 130 evaluated by the memory sub-system 101 at the time of writing or updating the log page 193. Further, the log page identifies a plan 321 for garbage collection 143 in the memory sub-system 101.

For example, the garbage collection plan 321 can include a target usage level 323 such that when the indicator 140 of usage level as evaluated by the garbage collection manager 113 in the memory sub-system 101 reaches the target usage level 323, the memory sub-system 101 starts the operations of garbage collection 147.

Based on the speed of change in the current usage level 327 in the log page 193, the garbage collection manager 113 in the host system 102 can estimate a suitable time to start host folding 143 such that the operations of host folding 143 can complete within a duration 313 for host folding 143. The duration 313 for the host folding 143 can be an estimated time period (e.g., determined with or without communications with the storage space tenants 107, . . . , 109), or a pre-determined or pre-selected duration 313 such that after the duration 313 the garbage collection manger 113 in the host system 102 terminates remaining operations of host folding 143 and hands the control of garbage collection related operations to the memory sub-system 101.

Optionally, the plan 321 can further include identifications 325 of targets for garbage collection 147.

For example, the garbage collection manager 113 in the memory sub-system 113 can select victim reclaim units (e.g., 125) that are scheduled for erasure when the indicator 140 as monitored by the memory sub-system 113 reaches the target usage level 323. The target identifications 325 can be configured to identify the victim reclaim units (e.g., 125) in the order in which the memory sub-system 113 plans to copy residual valid data from the victim reclaim units (e.g., 125) to other reclaim units in order to erase the victim reclaim units (e.g., 125). The identifications 325 in the log page 193 provide the host system 102 with an opportunity to perform host folding 143 to reduce valid data in the victim reclaim units (e.g., 125) before the memory sub-system 113 starts to copy remaining valid data from the victim reclaim units during garbage collection 147.

Optionally, the target identifications 325 include logical addresses (e.g., logical block address of block 134 in namespace 121) that use the storage resources (e.g., block 133 in reclaim unit 125) in the victim reclaim units (e.g., 125) as storage media. For example, in response to a determination that block 133 in the victim reclaim unit 125 has valid data, the garbage collection manager 113 in the memory sub-system 101 can use the address map 139 to look up the logical block address of block 134 in the namespace 121 that has valid data stored in the block 133 of the reclaim unit 125. The garbage collection manager 113 in the memory sub-system 101 can provide the logical block address of block 134 in the namespace 121 as part of the target identifications 325.

After extracting, from the log page 193, the logical addresses of the valid data that is scheduled/planned to be copied during the garbage collection 147, the garbage collection manager 113 in the host system 102 can determine corresponding the owners (e.g., storage space tenants 107, . . . , 109) and perform host folding 143 (e.g., as illustrated in FIG. 2 to FIG. 5) to invalidate (e.g., via deallocate 153 or deletion) or relocate the valid data (e.g., via overwrite 155 or write back).

In some instances, the garbage collection manager 113 in the host system 102 determines, during host folding 143, that the estimated remaining life of the valid data at a logical address (e.g., for the block 134 in the namespace 121) is expected to extend after the time of garbage collection 147. In response, the garbage collection manager 113 in the host system 102 can read the data from the logical address and write the data back to the logical address using a reclaim unit handle that is used to write data of life similar to the estimated remaining life of the data read from the logical address. Thus, the placement of valid data at the logical address can be relocated to a reclaim unit hosting data having similar life for write amplification reduction.

In general, the host system 102 knows the life spans of data of the data storage tenants 107, . . . , 109 better than the memory sub-system 101. For example, the garbage collection manger 113 in the host system 102 can communicate with the data storage tenants 107, . . . , 109 to obtain estimates and updated estimates of when the data at a logical address is to be changed, overwritten, deleted, or discarded. Thus, re-locating the placement of data in storage resources via the host system 102 specifying a reclaim unit using a data placement directive (e.g., 175 that specifies a reclaim unit handle) can achieve a better result in write amplification reduction than the garbage collection manager 113 in the memory sub-system 101 selecting a data placement location during garbage collection 143.

For improved efficiency, the memory sub-system 101 can be configured to provide the log page 193 after the usage level indicator 140 approaches the condition 141 for host folding 143.

For example, based on the speed of change in the usage level indicator 140 evaluated by the memory sub-system, the garbage collection manager 113 in the memory sub-system 101 can predict or estimate a time that is a predetermined host folding duration 313 before when the usage level indicator 140 reaches the target usage level 323 planned for the onset of garbage collection 147. The memory sub-system 101 can skip writing/updating the log page 193 before the estimated time, and start writing the log page 193 and/or updating the log page 193 more frequently after the estimated time.

When the log page 193 provides the logical addresses of data scheduled to be copied during garbage collection 147, the host system 102 can perform host folding 143 without tracking which logical addresses (e.g., 173) have storage media allocated on which reclaim unit (e.g., for association with reclaim unit identification 177 as in FIG. 10).

Periodically, the garbage collection manager 113 in the memory sub-system 101 can update the log page 193 to provide the identifications 325 of updated targets.

For example, after host folding 143 causes the data deletion from, or deallocation 153 of, a logical address that is previously included in the target identifications 325, the log page 193 can be updated to remove the logical address from the log page 193.

For example, after host folding 143 causes the data overwrite 155 at a logical address that is previously included in the target identifications 325, the log page 193 can be updated to remove the logical address from the log page 193.

For example, after data stored in an entire reclaim unit (e.g., 125) is invalidated (e.g., as a result of host folding 143 and/or normal operations of the storage space tenants 107, . . . , 109 in the host system), the memory sub-system 101 can erase the reclaim unit (e.g., 125) without garbage collection/copying data from the reclaim unit (e.g., 125). The memory sub-system 101 can erase the reclaim unit (e.g., 125) without waiting for the usage level indicator 140 to reach the target usage level 323. After erasing the reclaim unit (e.g., 125), the memory sub-system 101 can evaluate the indicator 140 and update the current usage level 327 identified in the log page 193 to reflect the increase of a free reclaim unit (e.g., 125).

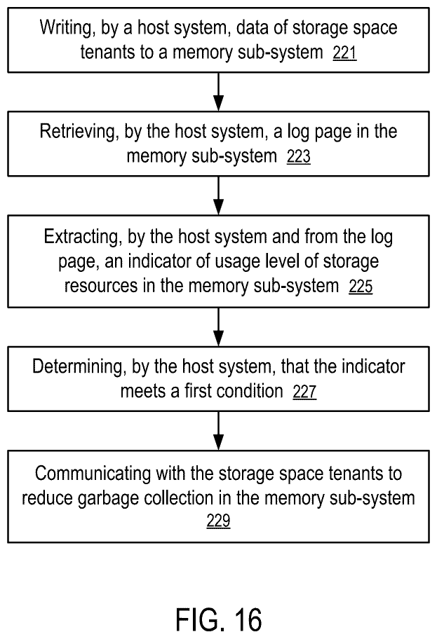

FIG. 16 shows a method to schedule operations of a host system related to garbage collection in a memory sub-system via a log page in the memory sub-system according to one embodiment. The method of FIG. 16 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 16 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 16 can be implemented using the garbage collection managers 113 of FIG. 1 to perform the operations discussed in connection with FIG. 2 to FIG. 15.

For example, the method of FIG. 16 can be used in connection with the method of FIG. 8 and/or the method of FIG. 12.

At block 221, the method of FIG. 16 includes writing, by a host system 102, data of storage space tenants 107, . . . , 109 to a memory sub-system 101.

Optionally, write commands (e.g., 107) having data placement directives (e.g., 175) can be used by the host system 102 to write data to the memory sub-system 101. Using data placement directives (e.g., 175) the host system 102 can cause the memory sub-system 101 to group data of similar life in reclaim units (e.g., 125) configured to be erased together.

For example, the data of the storage space tenants 107, . . . , 109 can be written into the memory sub-system 101 according to a nonvolatile memory express (NVMe) protocol supporting a technique of flexible direct placement (FDP).

At block 223, the method includes retrieving, by the host system, a log page 193 in the memory sub-system 101.

For example, the memory sub-system 101 can have a host interface 108, memory cells having a storage capacity 120 in one or more memory devices (e.g., 103, 104), and a controller 115 configured to provide data storage services over the host interface 108 using the storage capacity 120. The controller 115 can be configured to determine a first usage level (e.g., 327) of the memory cells and identify, in the log file 193, the first usage level (e.g., 327).

For example, the memory cells can be flash memory cells that are to be erased before being programmed to store data. The memory cells can be structure in blocks of pages where a block of pages is the smallest unit for an operation to erase memory cells. Further, the memory cells can be organized in reclaim units, where memory cells in a reclaim unit are to be erased together (e.g., via one or more erasure operations). An indicator 140 of usage level of the memory cells can be configured to be indicative of the level of availability of memory cells that have been erased and thus usable in programming for data storage.

For example, the indicator 140 can be based on a count of programmed memory cells that have been programmed to store data but have not yet been erased after programming, a count of free memory cells that have been erased and thus are available for programming without an operation of erasure, a ratio between the count of programmed memory cells and a total count of the memory cells in the memory sub-system 101, a ratio between the count of free memory cells and the total count of the memory cells in the memory sub-system 101, a count of in-use reclaim units that have programmed memory cells, a count of free reclaim units that have no programmed memory cells, a ratio between the count of in-use reclaim units and the total count of reclaim units in the memory sub-system 101, a ratio between the count of free reclaim units and the total count of reclaim units in the memory sub-system 101, etc.

The garbage collection manager 113 in the memory sub-system 101 can monitor the indicator 140 to determine whether to perform garbage collection 147. As the indicator 140 increases but before the indicator 140 reaches the condition 145 for garbage collection 147, the garbage collection manager 113 can record, in the log page 193, the current usage level 327 as identified by the indicator 140.

For example, the current usage level 327 identifies the level of use of storage resources (e.g., memory cells, reclaim units) in the memory sub-system 101 at a time of the log page 193 being written in the memory sub-system 101.

Optionally, the garbage collection manager 113 in the memory sub-system 101 can further identify, in the log file 193, a target usage level 323 of the memory cells as part of a garbage collection plan 321. The garbage collection manager 113 in the memory sub-system 101 can refrain from performing garbage collection 147 before the target usage level 323 is reached (e.g., when the current usage level 327 as specified in the log page 193 according to the indicator 140 evaluated/observed by the garbage collection manager 113 in the memory sub-system 101 reaches the target usage level 323).

For example, the log page 193 can be configured to provide health information, error information, or vendor specific information, or any combination thereof and further augmented to provide data related to garbage collection, such as the current usage level 327 of storage resources (e.g., memory cells, reclaim units), garbage collection plan 321, etc.

At block 225, the method includes extracting, by the host system 102 and from the log page 193, an indicator 140 of usage level (e.g., current usage level 327) of storage resources in the memory sub-system 101.

At block 227, the method includes determining, by the host system, that the indicator 140 meets a first condition 141.

At block 229, the method includes communicating, in response to the indicator 140 as extracted from the log page 193 meeting the first condition 140, with the storage space tenants 107, . . . , 109 to reduce garbage collection 147 in the memory sub-system 101.

For example, the method can further include recording a history 300 of usage levels (e.g., 301, 303, . . . , 305, 307) of storage resources in the memory sub-system 101, as identified from the log page 195 retrieved at a plurality time instances, and determining the first condition 141 from the history 300, as illustrated in FIG. 14.

Optionally, the method can further include extracting, by the host system 102 and from the garbage collection plan 321 in the log page 193, a target usage level 323 of storage resources in the memory sub-system 101. Since the memory sub-system 101 plans to refrain from garbage collection 147 before the target usage level 323 is reached, the host system 102 can perform host folding 143 in a duration 313 before the target usage level 323 is reached.

Optionally, the garage collection manager 113 in the memory sub-system 101 provides, in the log file 193, identifications 325 of targets for garbage collection 147 scheduled to be performed after the target usage level 323 is reached. For example, the identifications 325 of targets can include identifications of reclaim units (e.g., 125) and/or logical addresses having valid data stored in reclaim units scheduled to be erased after the target usage level 323 is reached.

For example, the method can further include: extracting, by the host system 102 and from the garbage collection plan 321 in the log page 193, a logical address provided as a target identification 325.

Since the memory sub-system 101 is scheduled to copy data from first storage resources allocated as media for the logical address to second storage resources after the target usage level 323 is reached, in order to erase the first storage resources (and other storage resources that are grouped together for erasure at the same time of erasing the first storage resources), it can be beneficial for the host system 102 to perform operations to remove the need for the data copying operation/garbage collection 147.

For example, to reduce write amplification, the garbage collection manager 113 in the host system 102 can identify the data owner/storage space tenant (e.g., 107 or 109) for the logical address and request the storage space tenant (e.g., 107 or 109) having data at the logical address to deallocate the logical address, to delete data from the logical address, or to overwrite data at the logical address.

For example, the garbage collection manager 113 in the host system 102 can determine (e.g., via a communication with the data owner/storage space tenant) an estimated remaining life of first data at the logical address. In response to a determination that the remaining life of the first data is to extend beyond an estimated time when the target usage level 323 is reached, the garbage collection manager 113 in the host system 102 can perform operations to cause a change of the placement of the first data in the storage resources 130 of the memory sub-system 101.

For example, to relocate the first data in the storage resources 130, the garbage collection manager 113 in the host system 102 can send a read command to the memory sub-system 101 to retrieve the first data from the logical address and then send a write command to memory sub-system 101 to write the first data back to the logical address. To execute the write command, the memory sub-system 101 to allocate free storage resources (e.g., free memory cells) to program the data into the allocated storage resources and mark the storage resources previously allocated to store the data for the logical address as having invalid data (and thus ready to be erased).

For example, the writing of the first data back to the logical address can be in accordance with a protocol of flexible direct placement. For example, the garbage collection manager 113 in the host system 102 can determine/select, based on the remaining life of the first data, a reclaim unit handle that is being used to write data of similar life as the remaining life of the first data. The garbage collection manager 113 in the host system 102 can specify the reclaim unit handle in a data placement directive (e.g., 175) in a write command (e.g., 171) to write the first data back to the logical address in the memory sub-system 101.

A non-transitory computer storage medium can be used to store instructions programmed to implement the garbage collection managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

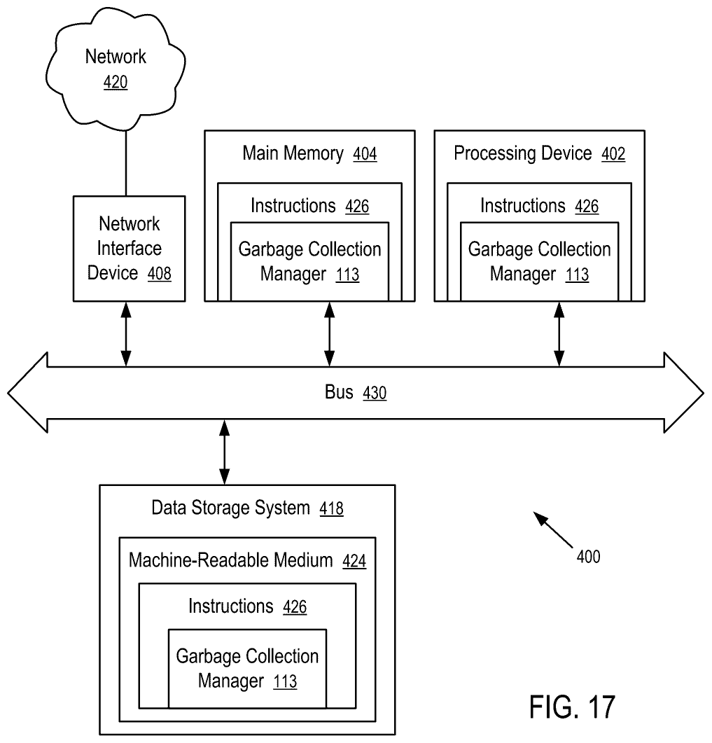

FIG. 17 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of garbage collection managers 113 (e.g., to execute instructions to perform operations corresponding to the garbage collection managers 113 described with reference to FIGS. 1-16). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the garbage collection managers 113 described with reference to FIGS. 1-16. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
writing, by a host system, data of storage space tenants to a memory sub-system;
retrieving, by the host system, a log page in the memory sub-system;
extracting, by the host system and from the log page, an indicator of usage level of storage resources in the memory sub-system;
determining, by the host system, that the indicator meets a first condition; and
communicating with the storage space tenants to reduce garbage collection in the memory sub-system.

2. The method of claim 1, wherein the log page is configured to further provide health information, error information, or vendor specific information, or any combination thereof.

3. The method of claim 2, wherein the data of the storage space tenants are written into the memory sub-system according to a nonvolatile memory express (NVMe) protocol.

4. The method of claim 1, wherein the indicator of the usage level identifies a current usage level of storage resources in the memory sub-system at a time of writing the log page by the memory sub-system; and the log page further includes a garbage collection plan.

5. The method of claim 4, further comprising:
extracting, by the host system and from the garbage collection plan in the log page, a target usage level of storage resources in the memory sub-system, wherein the memory sub-system is configured to refrain from garbage collection before the target usage level being reached.

6. The method of claim 5, further comprising:
extracting, by the host system and from the garbage collection plan in the log page, a logical address, wherein the memory sub-system is scheduled to copy data from first storage resources allocated as media for the logical address to second storage resources after the target usage level being reached.

7. The method of claim 6, wherein the communicating includes:
requesting a storage space tenant having data at the logical address to deallocate the logical address, to delete data from the logical address, or to overwrite data at the logical address.

8. The method of claim 6, further comprising:
determining, by the host system, a remaining life of first data at the logical address; and
in response to a determination that the remaining life of the first data is to extend beyond a time of the target usage level being reached:
reading, by the host system, the first data from the logical address in the memory sub-system; and
writing, by the host system, the first data back to the logical address in the memory sub-system.

9. The method of claim 8, wherein the writing of the first data is in accordance with a protocol of flexible direct placement.

10. The method of claim 9, further comprising:
determining, based on the remaining life of the first data, a reclaim unit handle; and
specifying the reclaim unit handle in a data placement directive in a write command to write the first data back to the logical address in the memory sub-system.

11. The method of claim 4, further comprising:
recording a history of usage levels of storage resources in the memory sub-system as identified from the log page retrieved at a plurality time instances; and
determining the first condition from the history.

12. A memory sub-system, comprising:
a host interface;
memory cells having a storage capacity; and
a controller configured to provide data storage services over the host interface using the storage capacity;
wherein the controller is configured to:
determine a first usage level of the memory cells; and
identify, in a log file, the first usage level.

13. The memory sub-system of claim 12, wherein the controller is further configured to:
identify, in the log file, a target usage level of the memory cells, wherein the controller is to refrain from garbage collection before the target usage level is reached.

14. The memory sub-system of claim 13, wherein the memory cells are grouped as reclaim units; and the first usage level is indicative of a ratio between:
a count of free reclaim units that have been erased and are ready for programming to store data; and
a count of total reclaim units in the memory sub-system.

15. The memory sub-system of claim 13, wherein the controller is further configured to:
provide, in the log file, identifications of targets for garbage collection scheduled after the target usage level is reached.

16. The memory sub-system of claim 15, wherein the identifications of targets include identifications of reclaim units.

17. The memory sub-system of claim 15, wherein the identifications of targets include identifications of logical addresses having valid data stored in reclaim units scheduled to be erased after the target usage level is reached.

18. A non-transitory computer storage medium storing instructions which, when executed in a host system of a computing device, cause the host system to perform a method, comprising:
retrieving a log page from a memory sub-system;
extracting, from the log page, an indicator of usage level of storage resources in the memory sub-system;
determining that the indicator meets a first condition; and
performing, in response to the indicator meeting the first condition, operations to reduce garbage collection in the memory sub-system.

19. The non-transitory computer storage medium of claim 18, wherein the method further comprises:
extracting, by the host system and from the log page, a target usage level of storage resources in the memory sub-system, wherein the memory sub-system is configured to refrain from garbage collection before the target usage level being reached.

20. The non-transitory computer storage medium of claim 19, wherein the method further comprises:
extracting, by the host system and from the garbage collection plan in the log page, a logical address, wherein the memory sub-system is scheduled to copy data from first storage resources allocated as media for the logical address to second storage resources after the target usage level being reached;
identifying an owner of first data at the logical address; and
requesting the owner of the first data at the logical address to deallocate the logical address, to delete data from the logical address, or to overwrite data at the logical address, or to provide an estimate of a remaining life of the first data.
